(19) United States
(12) Patent Application Publication
(10) Pub. No.: US 2025/0066987 A1
(43) Pub. Date: Feb. 27, 2025

(54) METHOD TO ESTIMATE THE TIME TO END OF A LAUNDRY-DRYING CYCLE AND LAUNDRY DRYING MACHINE TO CARRY OUT SAID METHOD

(71) Applicant: Electrolux Appliances Aktiebolag, Stockolm (SE)

(72) Inventor: Giorgio Pattarello, Porcia (IT)

(73) Assignee: Electrolux Appliances Aktiebolag, Stockholm (SE)

(21) Appl. No.: 18/721,583

(22) PCT Filed: Dec. 23, 2021
(86) PCT No.: PCT/EP2021/087614

§ 371 Date: Jun. 18, 2024

(51) Int. Cl. D06F 58/46; D06F 34/05; D06F 34/18; D06F 103/08; D06F 105/56

(52) U.S. Cl. CPC D06F 58/46; D06F 34/05; D06F 34/18; D06F 2103/08; D06F 2105/56

(57) ABSTRACT

A method to estimate the time to end (\hat{t}_{f,n}) of a laundry-drying cycle (DC(n)) performed by a laundry drying machine. The method comprises the following steps: defining a time to end learning function ( [symbol] ); during a drying cycle (DC(n)), collecting cycle parameters/signals (K(n), S_{raw}(n)); determining informative features (I(n)) based on the collected cycle parameters/signals (K(n), S_{raw}(n)); during the execution of the drying cycle (DC(n)), implementing the time to end learning function ( [symbol] ) based on the determined informative features (I(n)) to estimate the time to end (\hat{t}_{f,n}) of the current drying cycle (DC(n)); at the end of the current drying cycle (DC(n)), receiving a cycle feedback indicative of the actual duration (t_{f,n}) of the executed drying cycle (DC(n)); adapting the time to end learning function ( [symbol] ) based on the cycle feedback indicative of the actual duration (t_{f,n}) in order to determine an adapted time to end learning function ( [symbol] ); during the next drying cycle (DC(n+1)), implementing the adapted time to end learning function ( [symbol] ); to cause the data processing module to estimate the time to end (\hat{t}_{f,n}) of the next drying cycle (DC(n+1)).

### BACKGROUND ART

Nowadays, the use of laundry-drying machines is widespread. Laundry-drying machines are usually provided with electronic control systems, which are configured to control several operations depending on the drying-cycles/programs selected by the user.

Some electronic control systems are generally provided with electronic control units implementing algorithms, which estimate the time to end of the drying cycle. The time to end is the remaining time in a running drying cycle. In detail, the electronic control systems perform algorithms, which predict, time by time, during the cycle, the time left to run the laundry drying cycle. The remaining time determined by the system, i.e. the time to end, is usually displayed to the user by the control panel. In this way, at the beginning of the drying cycle, users are informed about how long they have to wait until the end of laundry drying cycle.

Currently the estimate of the time to end is carried out by means of algorithms that process a consistent number of machine control parameters/data, such as for example, data concerning the estimated weight of the laundry load, the selected drying program, the temperature of the drying air, the temperature of the refrigerant used by the heat pump device during the drying cycle, etc.

For example, EP2927366A1 filed by the Applicant concerns a method of correcting an estimation of an apparatus operation value for a laundry dryer wherein an algorithm estimates an initial operation value and/or a current operation value, subsequently estimates a present operation value by executing the algorithm during an apparatus operation cycle, and corrects the initial operation value and/or a current operation value to or by using the estimated present operation value.

The accuracy of the estimate of TTE depends on the optimization of the algorithm to manage different and unpredictable operating drying conditions such as load conditions. Furthermore, the algorithm cannot be modified on the basis of the precision required by the user

Moreover, laundry drying results/levels and/or information about drying procedure obtained by means of the control performed by the above cited algorithms, may be considered unfulfilling by the user.

Indeed, the actual laundry drying level as perceived by a user at the end of a drying process depends on subjective feelings or needs. This fact can be reason for dissatisfaction for the user, who can interact with the appliance in a limited number of ways, such as, for example, by changing the selection of a drying program by making use of the options available to adapt a basic drying program, trying to achieve the desired laundry drying level at the end of a drying cycle. In addition, with regard to the estimation of the time required to complete a running drying program, in case such estimation is affected by a relatively huge error, it can negatively impact on user time organization, causing, for example, the user to uselessly interrupt other activities to unload laundry from the appliance, while the appliance is still running.

Evidently, such program/options modifications, when available, are limited in number and in any case not further adaptable when selected, because each of them corresponds to a specific change in the drying algorithm well defined by the appliance manufacturer. There is therefore the need to provide a laundry-drying machine, which, on the one side, increases the drying accuracy as the operating drying conditions vary and, on the other side, is able to automatically adapt its operating/parameters in order to satisfy the laundry drying perceptions/preferences of each user.

It is further felt the need of providing a laundry drying machine wherein the correctness of the information given to the user is improved. According to the invention, the limits given by a fixed, i.e. non-adaptable or modifiable, policy to estimate the residual time to the end of a running drying cycle, are overcome. The estimate of the residual time to finish a running drying cycle is generally tuned by the laundry drying machine manufacturer taking as reference a limited number of load types and specified conditions in which the laundry drying machine operates. The variety of laundry compositions and machine working conditions, such as the temperature of the room where the laundry drying machine is placed, involved in the everyday use of a laundry drying machine are, substantially, not fully taken into consideration in a known policy designed to estimate the residual working time of a laundry drying machine. There is therefore the need of improving the information provided to the user, with regard to the estimate of time to complete a laundry drying program.

It is therefore an object of the present invention to provide a solution designed to obviate one or more problems due to limitations and disadvantages of the related art.

### DISCLOSURE OF INVENTION

According to the present invention, there is provided a method to estimate the time to end of a laundry-drying cycle performed by a laundry drying machine wherein said laundry drying machine comprises: an outer casing, a rotatable drum, which is arranged inside the outer casing and is structured to receive the laundry-load to be dried, electric motor means, which rotates said laundry drum based on a laundry-drying cycle, drying means for drying the laundry-load in said drum based on said drying cycle, an electronic control system which comprises: a data processing module, and a sensor system configured to provide cycle parameters and signals indicative of at least the moisture of said laundry-load, said method comprises the following steps: defining a time to end learning function; collecting, during a drying cycle, said cycle parameters and signals, determining informative features based on said collected cycle parameters and signals, during the execution of said drying cycle; implementing said time to end learning function by said data processing module based on said determined informative features to cause the data processing module to estimate the time to end of said current drying cycle; at the end of said drying cycle, receiving a cycle feedback indicative of the actual duration of said executed drying cycle; adapting said time to end learning function by said data processing module based on said cycle feedback indicative of said actual duration in order to determine an adapted time to end learning function; during the next drying cycle, implementing said adapted time to end learning function by said data processing module to cause the data processing module to estimate the time to end of the next drying cycle.

Preferably, said sensor system is configured to provide load moisture signals being indicative of the moisture of said laundry load, and/or drum motor torque signals being indicative of the torque provided by said electric motor; said informative features comprise: the mean of said load moisture signals, the variance of said moisture sensor signals in a predefined interval of the drying cycle, and the mean of the electrical torque signals in a predefined interval of said drying cycle.

In alternative and/or in addition, other measures of data dispersion referred to signals collected during said drying cycle can be used as informative features.

Preferably, said time to end learning function used to estimate said time to end of the current drying cycle is based on the following linear mathematical system

$${\hat{t}}_{f , n} = {ℳ}_{TTE , n} ( {μ}_{s , n} , {σ}_{s , n} , {μ}_{m , n} ) = {α}_{0 , n} + {α}_{1 , n} {μ}_{s , n} + {α}_{2 , n} {σ}_{s , n} + {α}_{3 , n} {μ}_{m , n}$$

wherein \hat{t}_{f,n} is the estimated time to end of the current drying cycle, α_{i,n} are coefficients of the linear mathematical model/function, μ_{s,n} is the mean of said load moisture sensor signal, σ_{s,n} is the variance of said moisture sensor signals and μ_{m,n} is the mean of the motor torque signals.

Preferably,

Aₙ=[α_{0,n} α_{1,n} α_{2,n} α_{3,n}]^{T} is a vector of parameters minimizing the sum of the squares of the residuals of the following mathematical matrix system

$${\underbrace{[ \begin{matrix}1 & {μ}_{s , 1} & {σ}_{s , 1} & {μ}_{m , 1} \\ 1 & {μ}_{s , 2} & {σ}_{s , 2} & {μ}_{m , 2} \\ ⋮ & ⋮ & ⋮ & ⋮ \\ 1 & {μ}_{s , n} & {σ}_{s , n} & {μ}_{m , n}\end{matrix} ]}}_{{Φ}_{TTE , n}} {A}_{n} = {\underbrace{[ \begin{matrix}{t}_{f , 1} \\ {t}_{f , 2} \\ ⋮ \\ {t}_{f , n}\end{matrix} ]}}_{{T}_{TTE , n}}$$

wherein Φ_{TTE,n} is a regression model matrix which contains the informative features I(n) collected during the operating of the laundry drying machine, T_{TTE,n} is a regression model matrix which contains the actual durations of the drying cycles DC(n) collected during the operating of the laundry drying machine; the method further comprises: determining, during the drying cycles, history data collections a set of variables that contain all the information of the past cycles needed to compute the update of the model when new data is available, and determining the vector Aₙ by performing the following matrix calculation

$${A}_{n} = {( {Φ}_{TTE , n}^{T} {Φ}_{TTE , n} )}^{- 1} {Φ}_{TTE , n}^{T} {T}_{TTE , n}$$

Preferably, the method comprises the step of: determining a time to end vector at the end of the current cycle, determining the drying cycles history data collections (H_{TTE,n}) of the current drying cycle (DC(n)) based on: drying cycles history data collections (H_{TTE,n-1}) determined during the previous drying cycles (DC(n−1)) and the time to end vector (V_{TTE,n}) determined during the current drying cycle DC(n).

Preferably, the method comprises the step of determining the time to end learning model to be used during the next drying cycle based on said drying cycles history data collections of the current drying cycle.

Preferably, said time to end learning function may be selected among: polynomial models, linear/kernelized support vector models, random forests, neural networks models.

Preferably, the method comprises the step of communicating said estimated time to end to a user communication device.

Preferably, the method comprises the step of adapting said time to end learning function in response to a user command.

According to the present invention, there is also provided a laundry drying machine comprising: an outer casing, a rotatable drum, which is arranged inside the outer casing and is structured to receive the laundry-load to be dried, electric motor means, which rotates said laundry drum based on a laundry-drying cycle, drying means for drying the laundry-load in said drum based on said drying cycle, a electronic control system which comprises: a data processing module, and a sensor system configured to provide cycle parameters and signals indicative of at least the moisture of said laundry-load,
wherein said data processing module is configured to: define a time to end learning function, collect said cycle parameters/signals during a drying cycle by said sensor system, determine informative features based on said collected cycle parameters and signals, implement said time to end learning function based on said determined informative features during the execution of said drying cycle to estimate a time to end of said current drying cycle, receive a cycle feedback indicative of the actual duration of said executed drying cycle at the end of said drying cycle, adapt said time to end learning function based on said cycle feedback indicative of said actual duration in order to determine an adapted time to end learning function, implement said adapted time to end learning function during the next drying cycle to estimate the time to end of the next drying cycle.

Preferably said sensor system is configured to provide load moisture signals being indicative of the moisture of said laundry load, and/or drum motor torque signals being indicative of the torque provided by said electric motor, said informative features comprise: the mean of said load moisture signals, the variance of said moisture sensor signals in a predefined interval of the drying cycle, and the mean of the electrical torque signals in a predefined interval of said drying cycle.

Preferably, said time to end learning function used to estimate said time to end of the current drying cycle is based on the following linear mathematical system

$${\hat{t}}_{f , n} = {ℳ}_{TTE , n} ( {μ}_{s , n} , {σ}_{s , n} , {μ}_{m , n} ) = {α}_{0 , n} + {α}_{1 , n} {μ}_{s , n} + {α}_{2 , n} {σ}_{s , n} + {α}_{3 , n} {μ}_{m , n}$$

wherein \hat{t}_{f,n} is the estimated time to end of the current drying cycle, α_{i,n} are coefficients of the linear mathematical model/function, μ_{s,n} is the mean of said load moisture sensor signal, σ_{s,n} is the variance of said moisture sensor signals and μ_{m,n} is the mean of the motor torque signals.

Preferably,

Aₙ=[α_{0,n} α_{1,n} α_{2,n} α_{3,n}]^{T} is a vector of parameters minimizing the sum of the squares of the residuals of the following mathematical matrix system

$${\underbrace{[ \begin{matrix}1 & {μ}_{s , 1} & {σ}_{s , 1} & {μ}_{m , 1} \\ 1 & {μ}_{s , 2} & {σ}_{s , 2} & {μ}_{m , 2} \\ ⋮ & ⋮ & ⋮ & ⋮ \\ 1 & {μ}_{s , n} & {σ}_{s , n} & {μ}_{m , n}\end{matrix} ]}}_{{Φ}_{TTE , n}} {A}_{n} = {\underbrace{[ \begin{matrix}{t}_{f , 1} \\ {t}_{f , 2} \\ ⋮ \\ {t}_{f , n}\end{matrix} ]}}_{{T}_{TTE , n}}$$

wherein Φ_{TTE,n} is a regression model matrix which contains the informative features I(n) collected during the operating of the laundry drying machine, T_{TTE,n} is a regression model matrix which contains the actual durations of the drying cycles DC(n) collected during the operating of the laundry drying machine,
wherein said data processing module is configured to: determining, during the drying cycles, history data collections a set of variables that contain all the information of the past cycles needed to compute the update of the model when new data is available; and determining the vector Aₙ by performing the following matrix calculation

$${A}_{n} = {( {Φ}_{TTE , n}^{T} {Φ}_{TTE , n} )}^{- 1} {Φ}_{TTE , n}^{T} {T}_{TTE , n}$$

Preferably, said data processing module is further configured to determine a time to end vector at the end of the current cycle, determine the drying cycles history data collections of the current drying cycle based on: drying cycles history data collections determined during the previous drying cycles and the time to end vector determined during the current drying cycle.

Preferably, said data processing module is configured to: determine the time to end learning model to be used during the next drying cycle based on said drying cycles history data collections of the current drying cycle.

Preferably said time to end learning function is selected among: polynomial models, linear/kernelized support vector models, random forests, neural networks models, linear models.

Preferably, said data processing module is configured to communicate said estimated time to end to a user communication device.

Preferably, said data processing module is configured to adapting said time to end learning function in response to a user command.

According to the present invention, there is also provided a computer program comprising instructions to cause the data processing module of the electronic control system of the laundry drying machine to execute the following steps: define a time to end learning function, collect said cycle parameters and signals during a drying cycle by said sensor system, determine informative features based on said collected cycle parameters and signals, implement said time to end learning function based on said determined informative features during the execution of said drying cycle to estimate a time to end of said current drying cycle, receive a cycle feedback indicative of the actual duration of said executed drying cycle at the end of said drying cycle, adapt said time to end learning function based on said cycle feedback indicative of said actual duration in order to determine an adapted time to end learning function, implement said adapted time to end learning function during the next drying cycle to estimate the time to end of the next drying cycle.

### BRIEF DESCRIPTION OF THE DRAWINGS

Further characteristics and advantages of the present invention will be highlighted in greater detail in the following detailed description of some of its preferred embodiments, provided with reference to the enclosed drawings. In the drawings, corresponding characteristics and/or components are identified by the same reference numbers.

In particular:

FIG. 1 illustrates schematically a perspective view of a laundry-drying machine according to the invention,

FIG. 2 represents a block diagram of a data processing unit of the electronic control system of the laundry-drying machine configured to determine the end of cycle of a drying cycle implemented by the laundry-drying machine,

FIG. 3 shows a flow chart of the operations implemented by a method to determine the end of cycle of a drying cycle implemented by the laundry-drying machine,

FIG. 4 represents a block diagram of a data processing unit of the electronic control system of the laundry-drying machine configured to determine the time to end of a drying cycle implemented by the laundry-drying machine,

FIG. 5 shows a flow chart of the operations implemented by a method to estimate the time to end of cycle of a drying cycle implemented by the laundry-drying machine,

FIG. 6 is a flow chart of the operation performed by the method to estimate the end of cycle and the time to end a drying cycle,

FIG. 7 represents a laundry-drying machine according to a different embodiment of the present invention,

FIG. 8 represents schematically the electronic control system of the laundry-drying machine shown in FIG. 7.

### DETAILED DESCRIPTION OF THE INVENTION

The terminology which will be used as follows is hereinafter defined for improving the clarity of the description and claims.

In the present description, where not stated differently, the term laundry-drying machine can be referred indiscriminately to any laundry treatment machine configured to perform a laundry-drying cycle/program, such as a laundry-drying machine or a laundry washing and drying machine.

Indeed, the control method of the present invention has proved to be particularly advantageous when applied to laundry-drying machines, called also dryers, or washing and drying machines, called also washer/dryers.

With the term time to end, it w % ill be understood the remaining time to cycle termination in a running laundry-drying cycle, e.g., if this operation is performed at the cycle beginning the predicted cycle duration can be called “initial” time to end. Moreover, with term end of cycle, it will be understood an operating condition of the drying cycle wherein a prefixed drying condition has been reached and the drying cycle terminates.

In other words, the end of cycle condition is the operating condition, wherein the drying of the load is completed. i.e. the desired dryness level is reached.

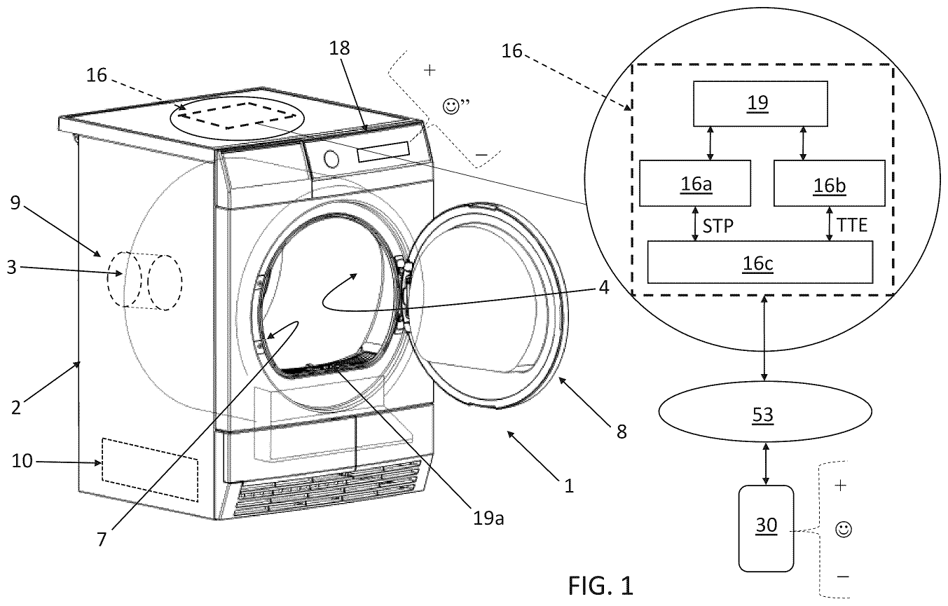

Number 1 in FIG. 1 schematically indicates, as a whole, a laundry tumble drying machine. Preferably, the laundry drying machine is a rotatable-drum laundry dryer 1 and comprises an outer casing 2, that preferably rests on the floor, on a number of feet.

Casing 2 supports a rotatable laundry drum 3, which defines a drying chamber 4 for laundry and rotates about a preferably, though not necessarily, horizontal axis of rotation (not shown).

In an alternative embodiment not shown, axis of rotation may be vertical or inclined. Drying chamber 4 has a preferably frontal access opening 7 closable by a door 8 preferably hinged to casing 2.

Drum 3 may be rotated about axis of rotation by an electric motor 9 schematically illustrated in FIG. 1. Drum 3 is fed with hot air heated by a heating device, schematically represented in FIG. 1 and indicated with reference number 10.

Hot air is fed into drum 3 preferably by a fan (not illustrated). Fan may preferably, though not necessarily, be driven by electric motor 9 or, in an alternative embodiment (not shown), by an auxiliary electric motor (not shown) independent of electric motor 9.

In the FIG. 1 example, one open side of the drum 3 of the laundry drier 1 is advantageously associated, in a rotatable and substantially air-tight way, to a perforated inner wall fixed to a lateral wall of casing 2 and through which hot air flows into drum 3. The other opened side of the drum 3 is advantageously associated, in a rotatable and substantially air-tight way, to a flange associated to casing 2 and interposed between door 8 and front access opening 7 of drum 3.

Heating device 10 may advantageously comprise one or more electric heating components, such as electric resistors (not shown) or, in an alternative embodiment, a refrigerant condensing heat exchanger of a heat pump system. The fan may blow a stream of drying air, heated by a heating device 10, preferably through perforated inner wall into drum 3. After contacting laundry inside drum 3, the moisture-laden drying air flows out of drum 3 and it is preferably directed to a moisture condensing device (not shown), which cools the drying air to condense the moisture inside it. For this purpose, condensing device may be supplied with cold air from outside the drier, and feeds the moisture-free air to fan, for being re-directed to the drum 3.

Alternatively, the moisture condensing device may be embodied as a refrigerant evaporator of a heat pump system.

It should be pointed out that moisture condensing device as described above applies, purely by way of example, to one possible embodiment of the present invention, and may be omitted in the case of an exhaust-type rotatable-drum laundry drier 1 (i.e. in which the hot and moisture-laden drying air from the rotatable laundry drum 3 is expelled directly out of rotatable-drum laundry drier 1).

The rotatable-drum laundry drier 1 also comprises an electronic control system 16, which is configured to control the operations of the laundry drier 1 on the basis of a drying cycle selected by a user via a control interface 18, i.e. a control panel.

It is understood that, in addition and/or alternately, the electronic control system 16 of the laundry dryer 1 may be provided with a communication module 16c which is configured to communicate (transmitting/receiving) data/signals to a user communication device 30 by means of a communication system 43. The communication system 43 may comprise any kind of wireless communication system. The user communication device 30 may comprise, for example, a wireless hand-held communication apparatus, such as smartphone, or tablet, or any similar mobile phone/device. The user communication device 30 may be programmed to memorize and implement an application software (mobile App or Apps) which, when executed by the user communication device 30, is configured to run the latter in order to generate a graphic user interface by which the user may select commands for the laundry dryer and/or receive information about the drying cycle. For example, as hereinafter disclosed in detail the application software may be configured so that the user may input/select a user feedback concerning the dryness of the laundry and communicates the selected user feedback to the electronic control system 16 of the laundry dryer 1.

The application software is further configured so that, when implemented by the user communication device 30, is configured to run the latter in order to receive and display data indicative of the estimated time to end and/or data relative the end of cycle condition from the laundry dryer 1.

The electronic control system 16 may comprise sensor system 19 provided with sensors/electronic circuits which are configured to measure/determine informative features/signals useful to inform the electronic control system 16 about the different possible moisture/load conditions.

Hereinafter to improve the clarity of the present invention it will be considered, as a not limitative example without loss of generality, a sensor system 19 which comprises one or more sensor devices 19a which are configured to determine/measure/estimate the humidity/moisture of the laundry in the drum 3 and provide electric signals indicative of the determined/measured/estimated laundry humidity/moisture.

In the exemplary embodiment shown in FIG. 1, sensor devices 19a comprise one or more contact electrode sensors arranged on the flange in a position facing the inside of the drum 3, for sensing the humidity/moisture of laundry. The measure of humidity/moisture of the laundry and generation of the electric signals may be carried out based on the variation or an electric parameter (i.e. impedances) of the laundry.

It is understood that the present invention is not limited to the use of the electric signal/data provided by sensor devices 19a as the type above disclosed, but other kind of sensor devices could be used in addition to, or as an alternative of, the electric signal/data of sensor devices.

The electronic control system 16 may comprise a data processing unit 16a, which is configured to determine the end of cycle condition and stops/terminates the drying cycle when the end of cycle condition is satisfied/determined.

Moreover, the electronic control system 16 comprises a data processing unit 16b, which is configured to predict/estimate the time to end, preferably at the beginning of the drying cycle, and communicates the estimated time to end to the user, by the control interface 18.

It is to be noted that, in the present invention, the data processing unit 16a may only optionally be provided in the same laundry drying machine where the data processing unit 16b is arranged. The further provision of a data processing unit 16a, configured to determine the end of cycle condition and stops/terminates the drying cycle when the end of cycle condition is satisfied/determined, can further improve the adaptation of the laundry drying machine to the user needs, but the further provision of a data processing unit 16a is not essential for the purpose of the present invention.

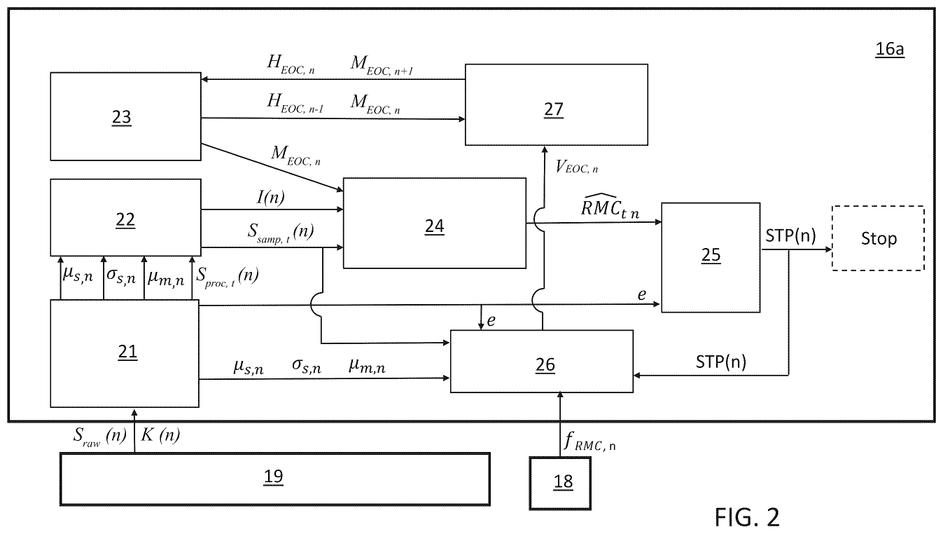

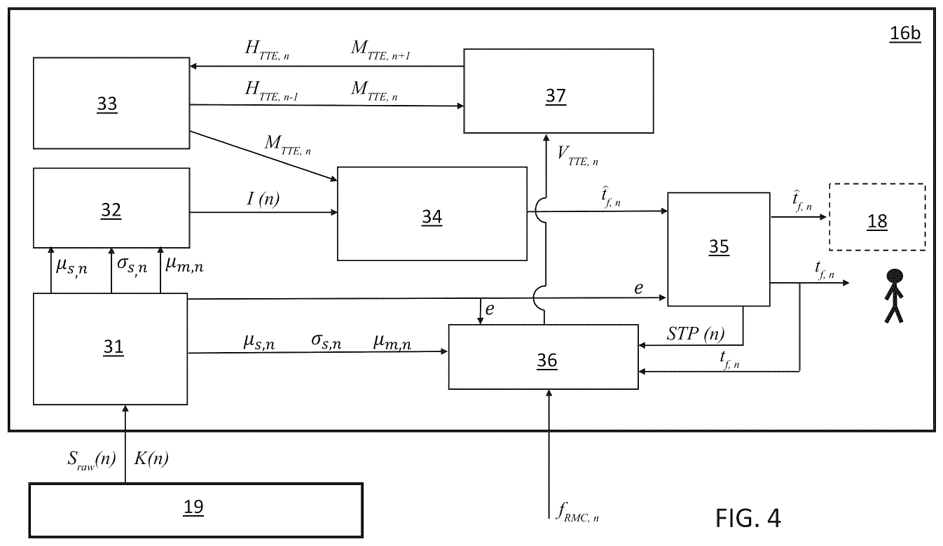

FIG. 2 schematically illustrates data processing modules of the data processing unit 16a, which are used to determine the “end of cycle condition”, whereas FIG. 4 schematically illustrates data processing modules of the data processing unit 16b used to predict/estimate the “time to end” of a drying cycle.

With reference to the exemplary embodiment shown in FIG. 2, the data processing unit 16a comprises a data/signals extracting module 21 which is configured to receive in input one or more drying-cycle parameters K(n) and cycle signals S_{raw}(n) during the implementation of the drying cycle DC(n).

Drying-cycle parameters K(n) may comprise, for example, values/information/data concerning the drying cycle DC(n), and/or relating to the laundry load. Drying-cycle parameters K(n) may further comprise cycle parameters setting defined by the user through the graphic user interface (or an app, voice controlled device, . . . ).

Hereinafter it will be assumed without loss of generality, that drying-cycle parameters K(n) relate to features of the drying cycle and laundry load. For example, drying-cycle parameters K(n) may comprise: the type of the laundry load (i.e. cotton, synthetic, wool, or other laundry loads), the type of drying cycle (ECO, fast, . . . ), final load conditions cycle options (iron dry, cupboard dry, extra dry, . . . ) and similar parameters characterizing the laundry load and/or the drying cycle DC(n) to be performed.

It is understood that cycle drying-cycle parameters K(n) received in input by the data/signal extracting module 21 are not limited to the values/information/data above described, but in addition or, as an alternative, other parameters/values associated with the load condition and in general with the overall drying process implemented by the laundry dryer 1 during the drying cycle DC(n) could be considered.

With regard to the cycle signals S_{raw}(n), they may comprise at least: signals provided by the sensor system 19 of the laundry dryer 1, signals from the electric motors, signals from the compressor of a heat pump system (if present), signals indicative of cycle timers, signals indicative of operational temperatures, and similar.

Hereinafter it will be assumed to improve the clarity of the present invention, without however loss of generality, that cycle signals received in input by the data/signals extracting module 21 comprise, for example: load moisture signals sₜ(wherein t is time) provided by the sensor device 19a, and/or electrical signals of the electric motor 9, i.e. signals indicating the torque of the motor mₜ.

The data/signals extracting module 21 is also configured to elaborate and process drying cycle parameters K(n) and cycle signals S_{raw,t}(n)=[s_{t,n}, m_{t,n}] during the drying cycle DC(n) in order to determine prefixed cycle informative features I(n) and signals S_{proc,t}(n)=s_{t,n}.

For example, with the aim to improve clarity of the present description, hereinafter explicit reference will be made on informative features I(n) comprising: the mean of the load moisture sensor signal s_{t,n} in a predefined interval of the drying cycle DC(n), hereinafter indicated with μ_{s,n} the variance of the moisture sensor signal s_{t,n} in a predefined interval of the drying cycle DC(n), hereinafter indicated with σ_{s,n}; and the mean of the motor torque signal m_{t,n} of motor 9, in a predefined interval of the drying cycle DC(n), hereinafter indicate with μ_{m,n}.

It is however understood that informative features I(n) are not limited to the mean μ_{s,n} variance σ_{s,n} and the mean μ_{m,n}, but in alternative and/or in addition, other measures of data dispersion referred to available cycle signals S_{raw}(n) could be used as the informative features I(n) to determine the end of cycle condition.

The data/signals extracting module 21 is also configured to provide in output the informative features I(n) and signals S_{proc,t}(n) processed during the drying cycle DC(n).

The data/signals extracting module 21 is also configured to provide “setting information” hereinafter indicated with “e” concerning parameters being indicative of the drying cycle DC(n), e.g. the drying program set by the user and the desired level of final humidity of the load.

Setting information “e” may comprise, for example, the kind of drying program selected by the user, i.e. cotton ECO, cotton, synthetic, mixed loads, . . . or similar information associated to the drying cycle or the preferences of the user, e.g., the option iron dry indicating the customer will iron the load after the drying cycle, or cupboard dry, indicating the customer desire a level of humidity that allows him/her in case to put the load directly in his/her closet.

With reference to FIG. 2, the data processing unit 16a further comprises a collecting module 22, which is configured to receive during the whole drying cycle DC(n), the informative features I(n) relating to the current drying cycle DC(n) and the cycle signals S_{proc,t}(n)=s_{t,n} (load moisture sensor signal) from the data/signals extracting module 21.

The collecting module 22 is further configured to sample at prefixed sampling time tₖ during the whole drying cycle DC(n) the cycle signal S_{proc,t}(n)=s_{t,n} (load moisture sensor signal) and memorize the sampled cycle signals S_{samp,t}(n)=[S_{0,n}, S_{tk,n}, S_{2tk,n}, . . . ].

The collecting module 22 is further configured to memorize the informative features I(n) comprising, i.e. in the exemplary embodiment, the mean μ_{s,n}, variance σ_{s,n} of the moisture sensor signal and the mean μ_{m,n} of the motor torque, determined in a predefined time interval.

The collecting module 22 is further configured to provide in output the sampled cycle signal S_{samp,t}(n)=[S_{0,n}, S_{tk,n}, S_{2tk,n}, . . . ] and the informative features I(n). With reference to FIG. 2, the control unit 16a further comprises a computational module 24 which is configured to receive in input an adaptive learning function [symbol] .

According with the present invention, with adaptive learning function [symbol] it is meant a learning mathematical model/algorithm which, when it is executed by the computational module 24 (e.g. a microprocessor) causes the computational module 24 to estimate the remaining moisture content [symbol] of the laundry load in the laundry dryer 1 based on the informative features I(n) and the sampled cycle signal S_{samp,t}(n)=[S_{0,n}, S_{tk,n}, S_{2tk,n}, . . . ] received from the collecting module 22.

For example, with the aim to improve clarity of the present description, hereinafter explicit reference will be made on an adaptive learning function [symbol] corresponding to a linear mathematical function/model, as follows:

$$\begin{matrix}= {ℳ}_{EOC , n} ( {μ}_{s , n} , {σ}_{s , n} , {μ}_{m , n} , {s}_{t , n} ) = \\ = {β}_{0 , n} + {β}_{1 , n} * {σ}_{s , n} + {β}_{2 , n} * {μ}_{s , n} + {β}_{3 , n} * {μ}_{m , n} + {β}_{4 , n} * {s}_{t , n}\end{matrix} \qquad a )$$

It is understood that the present invention is not limited to an adaptive learning function [symbol] belonging to the class of linear models, but other mathematical models (together with their own adaptation methods) could be used to estimate the remaining moisture content [symbol] .

For example, linear models may be replaced optionally with: polynomial models, linear/kernelized support vector models, and/or decision trees, and/or random forests, and/or neural networks models, and/or similar.

During the drying cycle DC(n), the computational module 24 may perform the adaptive learning function [symbol] corresponding to the function a), associated with the drying cycle DC(n), based on the received informative features I(n) and the sampled cycle signal S_{samp,t}(n) and estimate repeatedly (as hereinafter disclosed in detail) the remaining moisture content [symbol] of the laundry load in the laundry dryer 1.

According to the exemplary embodiment shown in FIG. 2, the computational module 24 implements the adaptive learning function [symbol] , which may solve a linear mathematical model, wherein the variables of the latter contain the informative features I(n) and sampled cycle signals S_{samp,t}(n)=[S_{0,n}, S_{tk,n}, S_{2tk,n}, . . . ] determined during the drying cycle DC(n).

According to the exemplary embodiment shown in FIG. 2, the computational module 24 may execute the adaptive learning function [symbol] in order to determine the remaining moisture content [symbol] of the drying cycle DC(n), for example as follows:
it is considered that Bₙ=[β_{0,n}, β_{1,n}, β_{2,n}, β_{3,n}, β_{4,n}] is a vector of parameters minimizing the sum of the squares of the residuals of the following mathematical system wherein a matrix system is involved:

$${\underbrace{[ \begin{matrix}1 & {μ}_{s , 1} & {σ}_{s , 1} & {μ}_{m , 1} & {s}_{0 , 1} \\ 1 & {μ}_{s , 1} & {σ}_{s , 1} & {μ}_{m , 1} & {s}_{1 , 1} \\ ⋮ & ⋮ & ⋮ & ⋮ & ⋮ \\ 1 & {μ}_{s , 1} & {σ}_{s , 1} & {μ}_{m , 1} & {s}_{{t}_{f} , 1} \\ 1 & {μ}_{s , 2} & {σ}_{s , 2} & {μ}_{m , 2} & {s}_{0 , 2} \\ 1 & {μ}_{s , 2} & {σ}_{s , 2} & {μ}_{m , 2} & {s}_{1 , 2} \\ ⋮ & ⋮ & ⋮ & ⋮ & ⋮ \\ 1 & {μ}_{s , 2} & {σ}_{s , 2} & {μ}_{m , 2} & {s}_{{t}_{f} , 2} \\ ⋮ & ⋮ & ⋮ & ⋮ & ⋮ \\ 1 & {μ}_{s , n - 1} & {σ}_{s , n - 1} & {μ}_{m , n - 1} & {s}_{0 , n - 1} \\ 1 & {μ}_{s , n - 1} & {σ}_{s , n - 1} & {μ}_{m , n - 1} & {s}_{1 , n - 1} \\ ⋮ & ⋮ & ⋮ & ⋮ & ⋮ \\ 1 & {μ}_{s , n - 1} & {σ}_{s , n - 1} & {μ}_{m , n - 1} & {s}_{{t}_{f} , n - 1}\end{matrix} ]}}_{{Ω}_{EOC , n - 1}} {B}_{n} = {\underbrace{[ \begin{matrix}{RMC}_{0 , 1} \\ {RMC}_{1 , 1} \\ ⋮ \\ {RMC}_{{t}_{f} , 1} \\ {RMC}_{0 , 2} \\ {RMC}_{1 , 2} \\ ⋮ \\ {RMC}_{{t}_{f} , 2} \\ ⋮ \\ {RMC}_{0 , n - 1} \\ {RMC}_{1 , n - 1} \\ ⋮ \\ {RMC}_{{t}_{f} , n - 1}\end{matrix} ]}}_{{P}_{EOC , n - 1}} \qquad b )$$

wherein

Ω_{EOC,n-1} and P_{EOC,n-1} are regression model matrices having dimensions which depends on the number of parameters used by the model and are progressively incremented based on the drying cycles DC(i).

More specifically:

Ω_{EOC,n-1} is a regression model matrix which contains the informative features I(i) (wherein i changes from 1 to n−1) which have been collected during the operating of the laundry dryer, and the signal S_{samp,t}(i) (wherein i changes from 1 to n−1), P_{EOC,n-1} is a regression model matrix which contains the remaining moisture content RMC_{t,i} of the laundry load (wherein i changes from 1 to n−1) which has been collected during the operating of the laundry dryer 1.

It is understood that the set composed by the matrices Ω_{EOC,n-1} and P_{EOC,n-1} forms the set H_{EOC,n-1} which will be hereinafter indicated with “history data collection”, which contains all the informative features (n−1), the signals S_{samp,t}(n−1) and remaining moisture content RMC_{t,n-1} which was collected during the drying cycles performed by the laundry dryer 1.

It is understood that for example a H_{EOC,n-1} may be determined in a controlled environment (e.g., like a laboratory) where this measure is available. During the following learning stages, where this measure or estimation is not available, such matrix will be built according to qualitative feedback translations.

It is understood that, at the beginning of the operation of the laundry dryer 1, the history data collection matrix H_{EOC,i} (i=n; DC(I)) may be defined based on laboratory tests. After the beginning of the operating of the laundry dryer (i>n−1), history data collection matrix H_{EOC,i} is built (updated and incremented) repeatedly during drying cycles DC(i) based on the collected informative features I(i), sampled cycle signals S_{samp,t}(i), and the quantitative feedback “translation” ρᵢ(f_{RMC,i}).

For example, the history data collection matrix H_{EOC,n-1} may be mathematically represented as follow:

$${H}_{EOC , n - 1} = \{ {Ω}_{EOC , n - 1} , {P}_{EOC , n - 1} \} == \{ [ \begin{matrix}1 & {μ}_{s , 1} & {σ}_{s , 1} & {μ}_{m , 1} & {s}_{0 , 1} \\ 1 & {μ}_{s , 1} & {σ}_{s , 1} & {μ}_{m , 1} & {s}_{1 , 1} \\ ⋮ & ⋮ & ⋮ & ⋮ & ⋮ \\ 1 & {μ}_{s , 1} & {σ}_{s , 1} & {μ}_{m , 1} & {s}_{{t}_{f} , 1} \\ 1 & {μ}_{s , 2} & {σ}_{s , 2} & {μ}_{m , 2} & {s}_{0 , 2} \\ 1 & {μ}_{s , 2} & {σ}_{s , 2} & {μ}_{m , 2} & {s}_{1 , 2} \\ ⋮ & ⋮ & ⋮ & ⋮ & ⋮ \\ 1 & {μ}_{s , 2} & {σ}_{s , 2} & {μ}_{m , 2} & {s}_{{t}_{f} , 2} \\ ⋮ & ⋮ & ⋮ & ⋮ & ⋮ \\ 1 & {μ}_{s , n - 1} & {σ}_{s , n - 1} & {μ}_{m , n - 1} & {s}_{0 , n - 1} \\ 1 & {μ}_{s , n - 1} & {σ}_{s , n - 1} & {μ}_{m , n - 1} & {s}_{1 , n - 1} \\ ⋮ & ⋮ & ⋮ & ⋮ & ⋮ \\ 1 & {μ}_{s , n - 1} & {σ}_{s , n - 1} & {μ}_{m , n - 1} & {s}_{{t}_{f} , n - 1}\end{matrix} ] , [ \begin{matrix}{RMC}_{0 , 1} \\ {RMC}_{1 , 1} \\ ⋮ \\ {RMC}_{{t}_{f} , 1} \\ {RMC}_{0 , 2} \\ {RMC}_{1 , 2} \\ ⋮ \\ {RMC}_{{t}_{f} , 2} \\ ⋮ \\ {RMC}_{0 , n - 1} \\ {RMC}_{1 , n - 1} \\ ⋮ \\ {RMC}_{{t}_{f} , n - 1}\end{matrix} ] \}$$

The computational module 24 may be configured to perform the mathematical system a) and may solve it to determine remaining moisture content

[symbol]

$$= {β}_{0 , n} + {β}_{1 , n} * {σ}_{s , n} + {β}_{2 , n} * {μ}_{s , n} + {β}_{3 , n} * {μ}_{m , n} + {β}_{4 , n} * {s}_{t , n - 1}$$

wherein parameters of the vector Bₙ₋₁ are determined by using, for example, a least square approach, solving the following matrix equation:

$${B}_{n - 1} = {( {Ω}_{EOC , n - 1}^{T} {Ω}_{EOC , n - 1} )}^{- 1} {Ω}_{EOC , n - 1}^{T} {P}_{EOC , n - 1} \qquad c )$$

With reference to FIG. 2, the data processing unit 16a further comprises a control module 25 which is configured to receive in input the cycle setting “e” and the remaining moisture content [symbol] .

The control module 25 is further configured to: determine a target moisture value t based on cycle setting “e”. The target moisture value t depends on the drying cycle DC(n) (drying program and dryness setting target, e.g., iron-dry, cupboard-dry, . . . ) set by user. The target moisture value t* indicates the final laundry moisture content associated to the selected drying program DC(n). Alternative embodiments might consider a different target per each program, a different learning model per each program and/or option or a unique model that includes as informative features all the program/options.

The control module 25 is also configured to determine the end of cycle condition when the remaining moisture content [symbol] satisfies a prefixed condition with the target moisture value t*. For example, the end of cycle condition may be determined when remaining moisture [symbol] reaches the target moisture value t*.

When the end of cycle condition is determined, the control module 25 generates a stop signal STP(n) causing the drying cycle DC(n) to be stopped. The drying cycle DC(n) is stopped at the instant t_{f,n} which will be considered hereinafter as the “actual” duration of the drying cycle DC(n).

The data processing unit 16a further comprises an ending collecting module 26, which is configured to receive in input: the informative features I(n), the cycle setting “e”, and the stop signal STP(n).

The stop signal STP(n) triggers/commands the ending collecting module 26 to start collecting and memorizing the informative features I(n) and samples the cycle signal S_{samp,t}(n) at the instant t_{f,n}. The ending collecting module 26 memorizes the informative features I(n), and the sampled cycle signal S_{samp,t}(n).

The ending collecting module 26 is further configured to receive in input at the end of the drying cycle DC(n), a qualitative feedback signal f_{RMC,n} which is indicative of the satisfaction of the user about dryness of the laundry load. In the exemplary embodiment illustrated in FIG. 1, the qualitative feedback signal f_{RMC,n} is a command/selection performed by the user of the laundry dryer 1 at the end of the drying cycle DC(n). The feedback signal f_{RMC,n} is provided to the ending collecting module 26 in response to a command/selection performed by the user and may comprise a number of satisfactions levels.

The ending collecting module 26 is further configured to elaborate the qualitative feedback signal f_{RMC,n} and determine/associate a “artificial quantitative dryness value” hereinafter indicated with pₙ based on the target moisture value t* and the feedback signal f_{RMC,n}.

According to an exemplary embodiment, the feedback f_{RMC,n} may comprise a value among a plurality of prefixed satisfaction levels.

In the exemplary embodiment shown in FIG. 1, the prefixed satisfaction levels may be three.

A first satisfaction level may correspond to a condition wherein the load final dryness level does not satisfy the user because laundry load is too dry.

A second level may correspond to a condition wherein the load final dryness level satisfies the user.

A third level may correspond to a condition wherein the load final dryness level of the laundry load does not satisfy the user because the load is too wet.

In the exemplary embodiment shown in FIG. 1 the load final dryness level may conveniently be selected by the user by a icon/marc comprised in the control interface 18.

For example, in FIG. 1 the level icon/mark “+” is used to select a condition wherein load is too dry; the level icon/mark “ [symbol] ” corresponds to a condition wherein the load satisfies the user; and the level icon/mark “−” corresponds to a condition wherein the load is too wet.

In the exemplary embodiment shown in FIG. 2 the ending collecting module 26 determines an artificial quantitative dryness value ρ(n) in the following manner:

ρ(n)=t*+a: when the feedback f_{RMC,n}. indicates that load is too wet (first icon/mark “−”)

ρ(n)=t*+b: when the feedback f_{RMC,n}. indicates that load is too dry (third icon/mark “+”)

ρ(n)=t*: when the feedback f_{RMC,n}. indicates that load final dryness level is satisfying (third icon/mark “ [symbol] ”).

Wherein:

$${t}^{*} = “ RMC [ \% ] target ” ( like for instance {t}^{*} = 0 \% )$$

a and b are two values which for example may be defined/tuned in lab with desired performance; for example a=+3%; and b=−3%. Of course, many more levels can be considered to support, for instance, possible embodiments where user feedback is not based on few selectable options but on “slider-like feedback bars”.

The ending collecting module 26 is further configured to output a vector V_{EOC,n} comprising:

$${V}_{EOC , n =} [ {μ}_{s , n} , {σ}_{s , n} , {μ}_{m , n} , {s}_{tf , n} , {ρ}_{n} ( {f}_{RMC , n} ) ] \qquad d )$$

The data processing unit 16a further comprises a function adapting module 27, which is configured to receive in input the vector V_{EOC,n} and the history data collection H_{EOCn-1}.

The function adapting module 27 is configured to update the history data collection H_{EOC,n-1} associated with the previous cycle (DN−1) based on the vector V_{EOC,n} in order to determine the history data collection H_{EOC,n} to be used in order to adapt the adaptive learning function [symbol] to [symbol] .

According to the exemplary schematic embodiment shown in the FIG. 2, function adapting module 27 merges the history data collection H_{EOC,n-1} with the vector V_{EOC,n}=[μ_{s,n}, σ_{s,n}, μ_{m,n}, s_{tf,n}, pₙ(f_{RMC,n})] in order to determine the new history data collection H_{EOC,n}:

$${H}_{EOC , n} = {H}_{EOC , n - 1} ⋃ {V}_{EOC , n} = \{ {Ω}_{EOC , n - 1} , {P}_{EOC , n - 1} \} ⋃ {V}_{EOC , n} = \{ {Ω}_{EOC , n} , {P}_{EOC , n} \}$$

$${H}_{EOC , n} = \{ {Ω}_{EOC , n - 1} , {P}_{EOC , n - 1} \} ⋃ {V}_{EOC , n} == \{ {\underbrace{[ \begin{matrix}1 & {μ}_{s , 1} & {σ}_{s , 1} & {μ}_{m , 1} & {s}_{0 , 1} \\ 1 & {μ}_{s , 1} & {σ}_{s , 1} & {μ}_{m , 1} & {s}_{1 , 1} \\ ⋮ & ⋮ & ⋮ & ⋮ & ⋮ \\ 1 & {μ}_{s , 1} & {σ}_{s , 1} & {μ}_{m , 1} & {s}_{{t}_{f} , 1} \\ 1 & {μ}_{s , 2} & {σ}_{s , 2} & {μ}_{m , 2} & {s}_{0 , 2} \\ 1 & {μ}_{s , 2} & {σ}_{s , 2} & {μ}_{m , 2} & {s}_{1 , 2} \\ ⋮ & ⋮ & ⋮ & ⋮ & ⋮ \\ 1 & {μ}_{s , 2} & {σ}_{s , 2} & {μ}_{m , 2} & {s}_{{t}_{f} , 2} \\ ⋮ & ⋮ & ⋮ & ⋮ & ⋮ \\ 1 & {μ}_{s , n - 1} & {σ}_{s , n - 1} & {μ}_{m , n - 1} & {s}_{0 , n - 1} \\ 1 & {μ}_{s , n - 1} & {σ}_{s , n - 1} & {μ}_{m , n - 1} & {s}_{1 , n - 1} \\ ⋮ & ⋮ & ⋮ & ⋮ & ⋮ \\ 1 & {μ}_{s , n - 1} & {σ}_{s , n - 1} & {μ}_{m , n - 1} & {s}_{{t}_{f} , n - 1} \\ 1 & {μ}_{s , n} & {σ}_{s , n} & {μ}_{m , n} & {s}_{{t}_{f} , n}\end{matrix} ]}}_{{Ω}_{EOC , n}} , {\underbrace{[ \begin{matrix}{RMC}_{0 , 1} \\ {RMC}_{1 , 1} \\ ⋮ \\ {RMC}_{{t}_{f} , 1} \\ {RMC}_{0 , 2} \\ {RMC}_{1 , 2} \\ ⋮ \\ {RMC}_{{t}_{f} , 2} \\ ⋮ \\ {RMC}_{0 , n - 1} \\ {RMC}_{1 , n - 1} \\ ⋮ \\ {RMC}_{{t}_{f} , n - 1} \\ {ρ}_{n} ( {f}_{RMC , n} )\end{matrix} ]}}_{{P}_{EOC , n}} \} \qquad e )$$

The function adapting module 27 may be configured to determine the new adaptive learning function [symbol] to be used in the next drying cycle DC(n+1) based on the updated history data collection H_{EOC,n}.

In the exemplary embodiment illustrated in FIG. 2 the new adaptive learning function [symbol] is determined by the following mathematical model:

$$\begin{matrix}{, n + 1}_{} = {ℳ}_{EOC , n + 1} ( {μ}_{s , n + 1} , {σ}_{s , n + 1} , {μ}_{m , n + 1} , {s}_{t , n + 1} ) = \\ = {β}_{0 , n + 1} + {β}_{1 , n + 1} * {σ}_{s , n + 1} + {β}_{2 , n + 1} * {μ}_{s , n + 1} + \\ {β}_{3 , n + 1} * {μ}_{m , n + 1} + {β}_{4 , n + 1} * {s}_{t , n + 1}\end{matrix} \qquad f )$$

associated to Bₙ₊₁=[β_{0,n+1}, β_{1,n+1}, β_{2,n+1}, β_{3,n+1}, β_{4,n+1}]^{T}
where Bₙ₊₁ is determined by implementing:

$${B}_{n + 1} = {( {Ω}_{EOC , n}^{T} {Ω}_{EOC , n} )}^{- 1} {Ω}_{EOC , n}^{T} {P}_{EOC , n} \qquad g )$$

The function adapting module 27 is further configured to output the new adaptive learning function [symbol] to be used in the next drying cycle DC(n+1) and the updated history data collection H_{EOC,n}.

The data processing unit 16a further comprises a memory module 23 which is configured to receive and memorize the new historical cycle information H_{EOC,n} to be used in the next cycle DC(n+1) to adapt the adaptive learning function [symbol] and determine the adaptive learning function [symbol] .

The memory module 23 is also configured to memorize the adaptive learning function [symbol] to be used to determine the end of cycle condition in the next drying cycle DC(n+1).

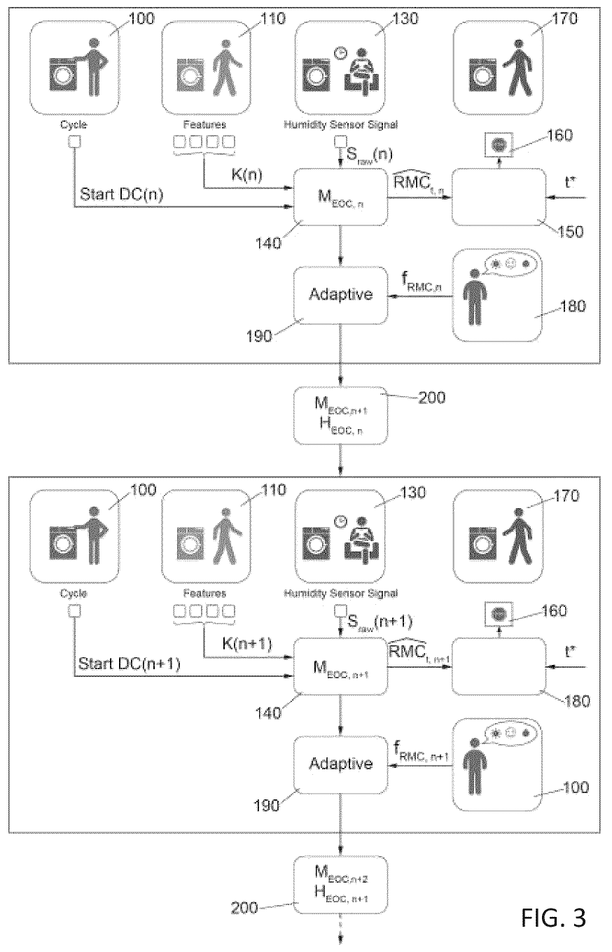

FIG. 3 schematically illustrates the steps performed by the data processing unit 16a for determining the end of cycle condition of the drying cycle DC(n).

It will be supposed that: the laundry dryer 1 is implementing the n-th drying cycle DC(n), the adaptive model [symbol] memorized in the memory module 23 has been adapted by the functioning adapting module 27 at the end t_{f,n-1} of the previous drying cycle DC(n−1).

At the beginning, the user loads the laundry in the drier 1, selects the program of drying cycle DC(n) (block 100) among a plurality of drying programs, and commands the laundry drier 1 to start the selected drying cycle DC(n).

During the drying cycle DC(n), (block 110) the extracting module 21 receives by means of the sensor system 19 of the laundry dryer 1, drying cycle parameters K(n) and cycle signals S_{raw}(n)={s_{t,n}, m_{t,n}}.

The data/signals extracting module 21 elaborates the drying cycle parameters K(n) and cycle signals S_{raw}(n) to determine the informative features I(n)=[ρ_{s,n}, σ_{s,n}, μ_{m,n},] and signals S_{proc,t}(n)=s_{t,n} which are provided to the collecting module 22.

During the drying cycle DC(n), the data/signals extracting module 21 further provides the setting information “e” to the ending collecting module 26 and to the control module 25.

Preferably, during the drying cycle DC(n), the collecting module 22 samples the load moisture signal S_{proc,t}(n)=s_{t,n} at prefixed intervals, and determines the sampled signals S_{samp,t}(n)=[S_{0,n}, s_{tk,n}, s_{2tk,n}, . . . ] the (block 130).

During the drying cycle DC(n), the collecting module 22 provides the sampled cycle signal S_{samp,t}(n) and the informative features I(n) to the computational module 24. The computational module 24 receives the adaptive learning function [symbol] from the memory module 23, the sampled cycle signal S_{samp,t}(n) and the informative features I(n) from the collecting module 22. The computational module 24 performs the adaptive learning function [symbol] based on the informative features I(n) and sampled cycle signal S_{samp,t}(n) to estimate the remaining moisture content of the laundry load [symbol] (block 140).

In the exemplary embodiment shown in FIG. 3, wherein the adaptive model [symbol] is based on a linear system, the remaining moisture content [symbol] is determined by equation a)

$$( n ) = {β}_{0 , n} + {β}_{1 , n} * {σ}_{s , n} + {β}_{2 , n} * {μ}_{s , n} + {β}_{3 , n} * {μ}_{m , n} + {β}_{4 , n} * {S}_{t ( n )}$$

Wherein Bn=[β_{0,n}, . . . β_{4,n}] is determined by implementing mathematical system g) above disclosed.

During the drying cycle DC(n), the control module 25 receives the remaining moisture content [symbol] determines the target moisture value t based on the cycle settings “e” and compares the estimated remaining moisture content load [symbol] with the target moisture target t* to determine the end of cycle condition of the drying cycle DC(n) based on the result of comparison (block 150).

When the remaining moisture content of the laundry load [symbol] reaches the moisture target t*, the control module 25 determines that end of cycle condition has been reached, and outputs the stop signal STP(n) (block 160) which stops the drying cycle DC(n) at the instant t_{f,n}.

After the drying cycle DC(n) is stopped, the user may open the door 8 of the laundry drier 1 (block 170), touches the dried laundry and based on his/her evaluation of the load final dryness (dryness satisfaction), inputs his/her qualitative feedback f_{RMC,n} (block 180).

The ending collecting module 26 determines/associates the artificial quantitative dryness value ρ(n) based on the qualitative feedback f_{RMC,i} and the moisture target t*. The ending collecting module 26 determines the vector V_{EOC,n} comprising [μ_{s,n}, σ_{s,n}, μ_{m,n}, s_{tf,n}, ρₙ(f_{RMC,n})] and provides it to the function adapting module 27. In the block 190, the function adapting module 27 receives from the memory module 23 the historical cycle information H_{EOC,n-1} and increments the historical cycle information H_{EOC,n-1} with the vector V_{EOC,n} in order to determine the updated historical cycle information H_{EOC,n}.

In the block 190, the function ad G module 27 determines the new adaptive learning function [symbol] to be used during the next drying cycle DC(n+1) based on the updated historical cycle information H_{EOC,n}.

The adaptive module 27 provides the incremented historical cycle information H_{EOC,n} and the adaptive learning model [symbol] to the memory module 23 (block 200).

During the next cycle DC(n+1), the data processing unit 16a performs the same operations of blocks 100-200 above disclosed, wherein: the computational module 24 performs the new adaptive learning function [symbol] based on the informative features I(n+1) and signals S_{samp,t}(n+1) in order to estimate the remaining moisture [symbol] , the control module 25 determines the end of cycle condition of the drying cycle DC(n+1) based on the estimated remaining moisture [symbol] and the target t*, the function adapting module 27 determines the historical cycle information H_{EOC,n+1} based on the previous historical cycle information H_{EOC,n} and vector V_{EOC,n+1} determined at the end of the drying cycle DC(n+1), the function adapting module 27 determines the adaptive learning function [symbol] to be used during the next drying cycle DC(n+2) based on the incremented historical cycle information H_{EOC,n+1}. It is understood that operations of blocks 100-200 above disclosed are performed during any subsequent drying cycle DC(j) (j changes from n+2).

FIG. 4 schematically illustrates the data processing modules of the data processing unit 16b, which are used to estimate the time to end, hereinafter indicated with \hat{t}_{f,n} of the drying cycle DC(n).

With reference to FIG. 4, the data processing unit 16b may comprise a data/signals extracting module 31 which is configured to receive in input one or more drying-cycle parameters K(n) and cycle signals S_{raw}(n) during the implementation of the drying cycle DC(n).

The data/signals extracting module 31 is also configured to output the informative features I(n). The extracting module 31 is also configured to provide setting information “e” comprising parameters being indicative of the drying cycle.

With reference to FIG. 4, the data processing unit 16b further comprises a collecting module 32, which is configured to receive the informative features I(n) relating to the current drying cycle DC(n) from the data/signals extracting module 31.

The collecting module 32 is further configured to memorize the informative features I(n), which in the exemplary embodiment may comprise e.g.: the mean μ_{s,n} of the moisture sensor signal, the variance σ_{s,n} of the moisture sensor signal and the mean μ_{m,n} of the motor torque determined in a predefined time interval.

It is however understood that informative features I(n) are not limited to the mean μ_{s,n} variance σ_{s,n} and the mean μ_{m,n}, but in alternative and/or in addition, other measures of data dispersion referred to available cycle signals S_{raw}(n) could be used as the informative features I(n).

The collecting module 32 is further configured to output the memorized informative features I(n).

With reference to FIG. 4, the data processing unit 16b further comprises a computational module 34 which is configured to receive in input an adaptive learning function

[symbol]

According with the present invention with adaptive learning function [symbol] , it is meant a learning model which, when it is executed by the computational module 34 (e.g. a microprocessor) causes the computational module 34 to estimate the time to end \hat{t}_{f,n}, based on the informative features I(n) received from the collecting module 32.

For example, with the aim to improve clarity of the present description, hereinafter explicit reference will be made on an adaptive learning function [symbol] corresponding to the following linear mathematical function/model.

$${\hat{t}}_{f , n} = {ℳ}_{TTE , n} ( {μ}_{s , n} , {σ}_{s , n} , {μ}_{m , n} ) = {α}_{0 , n} + {α}_{1 , n} {μ}_{s , n} + {α}_{2 , n} {σ}_{s , n} + {α}_{3 , n} {μ}_{m , n} \qquad h )$$

During the beginning interval of the drying cycle DC(n), the computational module 34 performs the adaptive learning function [symbol] (function h) based on the received informative features I(n) and estimate/predict (as hereinafter disclosed in detail) the time to end \hat{t}_{f,n}.

According to the exemplary embodiment shown in FIG. 4, the computational module 34 implements the adaptive learning function [symbol] which solves the linear mathematical model, wherein the variables of the latter are the informative features I(n) determined during the beginning interval of the drying cycle DC(n).

The adaptive learning function [symbol] may be used to determine the time to end \hat{t}_{f,n}, of the drying cycle DC(n), for example as follows.

It is considered that Aₙ=[α_{0,n}, α_{1,n}, α_{2,n}, α_{3,n}]^{T} is a vector of parameters minimizing the sum of the squares of the residuals of the following mathematical matrix equation:

$${\underbrace{[ \begin{matrix}1 & {μ}_{s , 1} & {σ}_{s , 1} & {μ}_{m , 1} \\ 1 & {μ}_{s , 2} & {σ}_{s , 2} & {μ}_{m , 2} \\ ⋮ & ⋮ & ⋮ & ⋮ \\ 1 & {μ}_{s , n} & {σ}_{s , n} & {μ}_{m , n}\end{matrix} ]}}_{{Φ}_{TTE , n}} {A}_{n} = {\underbrace{[ \begin{matrix}{t}_{f , 1} \\ {t}_{f , 2} \\ ⋮ \\ {t}_{f , n}\end{matrix} ]}}_{{T}_{TTE , n}} \qquad i )$$

### Wherein

Φ_{TTE,n} and T_{TTE,n} are regression model matrices having dimensions which depend on the number of parameters used by the model.
Φ_{TTE,n} is a regression model matrix which contains the informative features I(i) (wherein i changes from 1 to n) which has been collected during the operating of the laundry dryer,
T_{TTE,n} is a regression model matrix which contains the actual duration of the drying cycles DC(i), t_{f,i} which has been collected during the operating of the laundry dryer 1.

It is understood that the set composed by the matrices Φ_{TTE,n} and T_{TTE,n} forms the set H_{TTE,n} hereinafter indicated with “history data collection” which contains all the informative features I(i) and actual durations ty, of the drying cycles DC(i) of drying cycles performed by the laundry dryer 1.

It is understood that at the beginning of the operating of the laundry dryer 1, the history data collection matrix H_{TTE,n} may be predefined based on laboratory tests. The history data collection set H_{TTE,n} may be mathematically represented as follow:

$${H}_{TTE , n} = \{ {Φ}_{TTE , n} , {Φ}_{TTE , n} \} = \{ [ \begin{matrix}1 & {μ}_{s , 1} & {σ}_{s , 1} & {μ}_{m , 1} \\ 1 & {μ}_{s , 2} & {σ}_{s , 2} & {μ}_{m , 2} \\ ⋮ & ⋮ & ⋮ & ⋮ \\ 1 & {μ}_{s , n} & {σ}_{s , n} & {μ}_{m , n}\end{matrix} ] , [ \begin{matrix}{t}_{f , 1} \\ {t}_{f , 2} \\ ⋮ \\ {t}_{f , n}\end{matrix} ] \} \qquad l )$$

The computational module 34 may be configured to perform the mathematical system h) wherein Aₙ is determined by implementing the following matrix operation

$${A}_{n} = {( {Φ}_{TTE , n}^{T} {Φ}_{TTE , n} )}^{- 1} {Φ}_{TTE , n}^{T} {Φ}_{TTE , n} \qquad m )$$

It is understood that the resent invention is not limited to an adaptive learning function [symbol] , belonging to the class of linear models but other mathematical models (together with their own different adaptation methods) could be used to estimate the time to end. For example, linear models may be replaced optionally with: polynomial models, linear/kernelized support vector models, and/or random forests, and/or neural networks models, and/or similar.

With reference to FIG. 4, the data processing unit 16b further comprises a control module 35 which is configured to receive in input the cycle setting “e” and the estimated time to end \hat{t}_{f,n}. The control module 35 may display the estimated time to end \hat{t}_{f,n}, to the user by the control interface 18.

At the end of cycle, for example when the end of cycle condition is determined, the stop signal STP(n) is provided to the control module 35 and the drying cycle DC(n) is stopped. In other words, the drying cycle DC(n) (i=n) is stopped by the stop signal STP(n) at the instant t_{f,n} which is the actual duration of the drying cycle DC(n). The stop signal STP(n) is generated by a control module monitoring that a pre-determined condition to end the cycle is met. Said module may be the control module 25 of the data processing unit 16a, if the latter is provided together with the data processing unit 16b, or it can be another module provided in a data processing unit less complex than the unit 16a.

The data processing unit 16b further comprises an ending collecting module 36 which is configured to receive in input: the informative features I(n), the cycle setting “e”, the instant t_{f,n}. Preferably the ending collecting module 36 may also receive the feedback signal f_{RMC,n}. For example, the feedback signal f_{RMC,n} may be provided to the ending collecting module 36 of the processing unit 16b and to the ending collecting module 26 of the data processing unit 16a, when the system provides both the time to end and the end of cycle condition.

The stop signal STP(n), forwarded by the control module 35, commands the ending collecting module 36 to start collecting and memorizing the informative features I(n) at the instant t_{f,n}. The ending collecting module 36 memorizes the informative features I(n), and the instant t_{f,n} corresponding to the actual duration of the drying cycle DC(n).

The ending collecting module 36 is further configured to output a vector V_{TTE,n} comprising:

$${V}_{TTE , n} = [ {μ}_{s , n} , {σ}_{s , n} , {μ}_{m , n} , {t}_{f , n} ] \qquad n )$$

The data processing unit 16b further comprises a function adapting module 37, which is configured to receive in input the vector V_{TTE,n} and the history data collection H_{TTE,n-1}.

The function adapting module 37 is configured to update the history data collection H_{TTE,n-1} based on the vector V_{TTE,n} in order to determine the history data collection H_{TTE,n} to be used to adapt the adaptive learning function [symbol] .

According to the schematic exemplary embodiment shown in the FIG. 2, function adapting module 37 merges the history data collection H_{TTE,n-1} with the vector V_{TTE,n} in order to determine the new history data collection

For example,

$$\begin{matrix}{H}_{TTE , n} = {H}_{TTE , n - 1} ⋃ {V}_{TTE , n} \\ = \{ {Φ}_{TTE , n - 1} , {T}_{TTE , n - 1} \} ⋃ {V}_{TTE , n} \\ = \{ {Φ}_{TTE , n} , {T}_{TTE , n} \}\end{matrix} \qquad o )$$

$$\begin{matrix}{H}_{TTE , n} = \{ {Φ}_{TTE , n - 1} , {T}_{TTE , n - 1} \} ⋃ {V}_{TTE , n} \\ == \{ {\underbrace{[ \begin{matrix}1 & {μ}_{s , 1} & {σ}_{s , 1} & {μ}_{m , 1} \\ ⋮ & ⋮ & ⋮ & ⋮ \\ 1 & {μ}_{s , n - 1} & {σ}_{s , n - 1} & {μ}_{m , n - 1} \\ 1 & {μ}_{s , n} & {σ}_{s , n} & {μ}_{m , n}\end{matrix} ]}}_{{Φ}_{TTE , n}} , {\underbrace{[ \begin{matrix}{t}_{f , 1} \\ ⋮ \\ {t}_{f , n - 1} \\ {t}_{f , n}\end{matrix} ]}}_{{T}_{TTE , n}} \}\end{matrix}$$

The function adapting module 37 may be configured to determine the new adaptive learning function [symbol] to be used in the next drying cycle DC(n+1) based on the updated history data collection H_{TTE,n}.

In the exemplary embodiment illustrated in FIG. 4 the new adaptive learning function [symbol] is determined by the following mathematical model/function:

$${\hat{t}}_{f , n} = {M}_{TTE , n + 1} ( {μ}_{s , n + 1} , {σ}_{s , n + 1} , {μ}_{m , n + 1} ) = {α}_{0 , n + 1} + {α}_{1 , n + 1} {μ}_{s , n + 1} + {α}_{2 , n + 1} {σ}_{s , n + 1} + {α}_{3 , n + 1} {μ}_{m , n + 1} \qquad p )$$

$$associated to {A}_{n + 1} = {[ {α}_{0 , n + 1} {α}_{1 , n + 1} {α}_{2 , n + 1} {α}_{3 , n + 1} ]}^{T}$$

where Aₙ₊₁ is determined by implementing:

$${A}_{n + 1} = {( {Φ}_{TTE , n}^{T} {Φ}_{TTE , n} )}^{- 1} {Φ}_{TTE , n}^{T} {T}_{TTE , n} \qquad q )$$

The function adapting module 37 is further configured to provide in output the new adaptive learning function [symbol] to be used in the next drying cycle DC(n+1) and the new history data collection H_{TTE,n}.

The data processing unit 16b further comprises a memory module 33 which is configured to receive and memorize the new historical cycle information H_{TTE,n} to be used in the next cycle DC(n+1) to adapt the adaptive learning function [symbol] and determine the adaptive learning function [symbol] .

The memory module 33 is also configured to memorize the adaptive learning function [symbol] to be used to estimate the time to end \hat{t}_{f,n+1} in the next drying cycle DC(n+1).

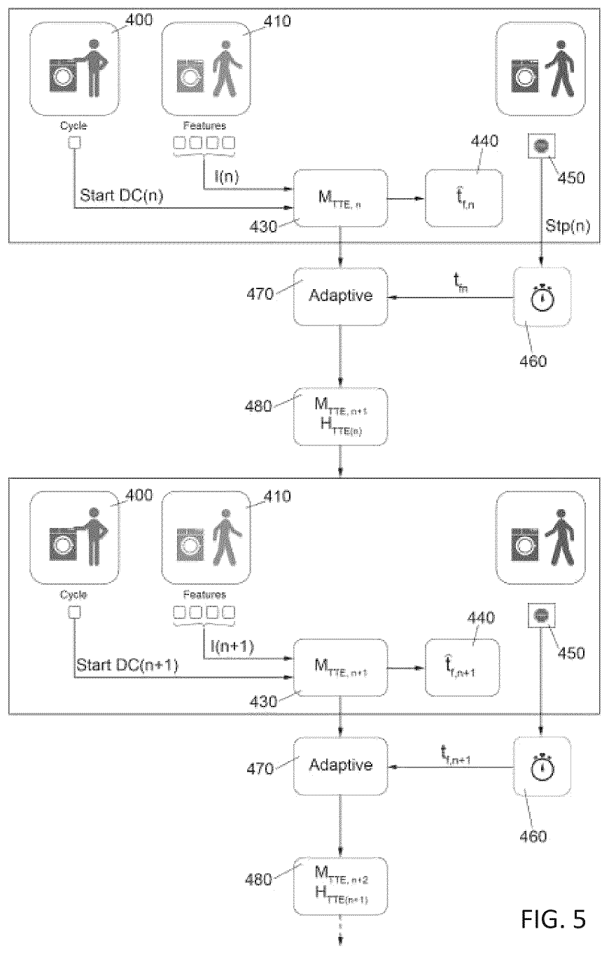

FIG. 5 schematically illustrates the steps performed by the data processing unit 16b to estimate/predict the time to end \hat{t}_{f,n} of a drying cycle DC(n).

It will be supposed that: the laundry dryer 1 is implementing the n-th drying cycle DC(n), the adaptive model [symbol] memorized in the memory module 33 has been adapted by the adaptive module 37 at the end t_{f,n-1} of the previous drying cycle DC(n−1).

At the beginning, the user loads the laundry in the drier 1, selects a drying cycle DC(n) (block 400) among a plurality of selectable drying cycles (drying programs), and commands the laundry drier 1 to start the selected drying cycle DC(n).

At the beginning of the drying cycle DC(n) (block 410), the extracting module 31 receives by means of the sensor system 19 of the laundry dryer 1, cycle parameters K(n) and cycle signals S_{raw}(n)={s_{t,n}, m_{t,n}}.

The extracting module 31 elaborates the cycle parameters K(n) and cycle signals S_{raw}(n) to determine the informative features I(n)=[μ_{s,n}, σ_{s,n}, μ_{m,n}] which are provided to the collecting module 32. In this step, the collecting module 32 memorizes the received informative features I(n)=[μ_{s,n}, σ_{s,n}, μ_{m,n}] (block 410).

During the drying cycle DC(n), the data % signals extracting module 31 further provides the setting information “e” to the ending collecting module 36 and to the control module 35.

The computational module 34 receives the adaptive learning function [symbol] from the memory module 33, and the informative features I(n) from the collecting module 32 (block 430). The computational module 34 performs the adaptive learning function [symbol] based on the informative features I(n) in order to estimate the time to end time to end \hat{t}_{f,n} (block 440).

In the exemplary embodiment shown in FIG. 5 wherein the adaptive learning function [symbol] is based on a linear system, the time to end \hat{t}_{f,n} is determined by the following equation r)

$${\hat{t}}_{f , n} = {M}_{TTE , n} ( {μ}_{s , n} , {σ}_{s , n} , {μ}_{m , n} ) = {α}_{0 , n} + {α}_{1 , n} {μ}_{s , n} + {α}_{2 , n} {σ}_{s , n} + {α}_{3 , n} {μ}_{m , n}$$

The control module 35 receives and displays the estimated time to end \hat{t}_{f,n} by the control interface 18.

At the end of cycle, the drying cycle DC(n) is stopped (block 450) the control module 35 determines the actual duration t_{f,n} (block 460).

The ending collecting module 36 determines the vector V_{TTE,n}comprising [μ_{s,n}, σ_{s,n}, μ_{m,n}, t_{f,n}] and provides it to the function adapting module 37 (block 470).

According to an embodiment, wherein the electronic control system 16 is configured to perform both [symbol] model adaptation for the time to end estimation and [symbol] model adaptation for the end of cycle based on a qualitative feedback f_{RMC}, the parameter r might be used instead of t_{f,n} in the definition of vector V_{TTE,n}.

In this case, for example, the parameter r may be defined as a function of the actual duration t_{f,n} and the qualitative feedback f_{RMC}, i.e., τ=g(t_{f,n}, f_{RMC}).

In this condition a possible example is the following:

$$τ = \{ \begin{matrix}{t}_{f , j} + ε & if {f}_{RMC , j} = - \\ {t}_{f , i} & if {f}_{RMC , j} = \\ {t}_{f , j} - ε & if {f}_{RMC , j} = +\end{matrix}$$

with ε=ε̅ (a fixed amount of time) or ε=δt_{f,j} with 0<δ<1 (a percentage of the actual cycle duration), where ε̅ (or δ) are parameters tuned according to expected performance. As a consequence of this, V_{TTE,n} may be defined as V_{TTE,n}=[μ_{s,n}, σ_{s,n}, μ_{m,n}, g(t_{f,n}, f_{RMC})].

The adaptive module 37 receives from the memory module 33 the historical cycle information H_{TTE,n-1} and increments the historical cycle information H_{TTE,n} with the vector V_{TTE,n} in order to determine the updated historical cycle information H_{TTE,n}. The adaptive module 37 determines the new adaptive learning function [symbol] to be used during the next drying cycle DC(n+1) based on the historical cycle information H_{TTE,n} and

[symbol]

The adaptive module 37 provides the incremented historical cycle information H_{TTE,n} and the adaptive model [symbol] to the memory module 33 (block 480).

During the next cycle DC(n+1), the data processing unit 16b performs the same operations of blocks 400-480 above disclosed, wherein: the computational module 34 performs the new adaptive learning function [symbol] in order to estimate the time to end \hat{t}_{f,n+1}, the control module 35 displays the estimated time to end \hat{t}_{f,n+1}. the function adapting module 37 determines the historical cycle information H_{TTE,n+1} incremented based on vector V_{TTE,n+1} determined at the end of the drying cycle DC(n+1), the adaptive module 37 determines the adaptive learning function [symbol] to be used during the next drying cycle DC(n+2) based on the previous adaptive learning function [symbol] and the incremented historical cycle information H_{TTE,n+1}. It is understood that operations of blocks 400-480 above disclosed are performed during any subsequent drying cycle to estimate the time to end \hat{t}_{f,n+j} (wherein j changes from n+2).

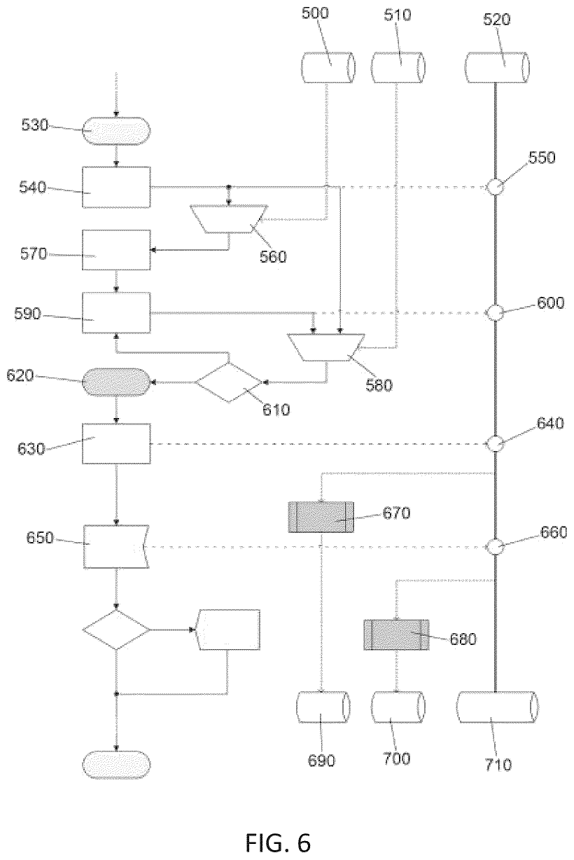

FIG. 6 is a flow chart of an exemplary embodiment of a method implemented by the electronic control system 16 of the laundry dryer 1, which when is implemented by the electronic control system 16 causes the latter to estimates both the time to end \hat{t}_{f,n}. preferably at the beginning of the drying cycle DC(n), and the remaining moisture [symbol] n order to determine the end of cycle condition to stop the drying cycle DC(n). It is assumed that at the end of the previous drying cycle DC(n−1), the method has updated the previous adaptive learning functions [symbol] , [symbol] and determined the adaptive learning functions [symbol] , [symbol] to be used during the drying cycle DC(n).

Moreover, it is assumed that at the end of the previous drying cycle DC(n−1), the method has updated the historical cycle information H_{TTE,n-2}, H_{EOC,n-2} and determined the historical cycle information H_{TTE,n-1}, H_{EOC,n-1}.

The adaptive learning function [symbol] is memorized in the memory module 33 (block 500), the adaptive learning function [symbol] is memorized in the memory module 23 (block 510), and the historical cycle information H_{TTE,n-1}, H_{EOC,n-1} are memorized in the memory modules 33 and 23, respectively (block 520).

At the beginning, the laundry dryer 1 starts the drying cycle DC(n) selected by the user (block 530).

The method performs the extraction of the cycle parameters K(n) and cycle signals S(n) by the sensor system 19 and determines the informative features I(n) (block 540). The so determined informative features I(n) are memorized (block 550). [symbol] The method further comprises the step of performing the adaptive model [symbol] stored in the memory module 33 by means of the computational module 34 based on information features I(n) (block 560) in order to predict/estimate and display the time to end \hat{t}_{f,n}. (block 570).

During the drying cycle DC(n) the method further comprises the step of repeatedly sampling the cycle signals S_{proc}(n) by the collecting module 22 (block 590) and provide it, together with the informative features I(n) already collected, to the computational module 24 which estimates the remaining moisture [symbol] by executing the adaptive learning function [symbol] on the informative features I(n) and sampled signals Sₛₐₘₚ(n) (block 580). In block 600, sampled signals Sₛₐₘₚ(n) are memorized.

In the block 610, the method compares the estimated remaining moisture [symbol] with the target t*.

If the estimated remaining moisture [symbol] is greater than the target t*, the method repeats the steps of block 590, 580 and 610, i.e. by extracting the signals S_{samp,t}(n), and estimating the remaining moisture [symbol] by means of the adaptive learning function [symbol] , and finally comparing remaining moisture [symbol] with the target t*. If the estimated remaining moisture [symbol] is equal or lower than the target t*, the method determines the end of cycle condition and stops the drying cycle DC(n) (block 620).

At the end of the drying cycle DC(n), the method determines the actual duration t_{f,n} (block 630), determines the vector V_{TTE,n} and updates the historical cycle information H_{TTE,n-1} based on the vector V_{TTE,n} (block 640) in order to determine the historical cycle information H_{TTE,n} to be memorized in the memory module 33 (block 710).

In block 650, the method receives from the user the qualitative feedback f_{RMC,n} and determines/associates the artificial quantitative dryness value ρ(n).

In block 660, the method determines the vector V_{EOC,n} and updates the historical cycle information H_{EOC,n-1} based on the vector V_{EOC,n} in order to determine the information H_{EOC,n} (blocks 660) which is memorized in the memory module 23 (block 710).

In block 670, the method elaborates the historical cycle information H_{TTE,n} in order to determine the adaptive learning function [symbol] to be used in the next drying cycle DC(n+1). The adaptive learning function [symbol] is memorized in the memory module 33 (block 690).

In block 680, the method elaborates the historical cycle information H_{EOC,n} in order to determine the adaptive learning function [symbol] to be used in the next drying cycle DC(n+1). The adaptive learning function [symbol] is memorized in the memory module 23 (block 700).

It is understood that the models of the end of cycle and the time to end could be updated automatically by the electronic control system 16 after each drying cycle and/or in response to a command given by the user.

For example, the command could be given in response to a message provided by the graphic user interface to the user such as: “Do you want us to adapt the models based on your feedback?”.

The laundry dryer and method above disclosed have the advantage of improving the accuracy of the estimation of the time to end.

Since the method continuously updates the adaptive learning function with new information collected from the laundry dryer, such as the actual durations of the drying cycles and the informative features which characterize the drying cycles, the accuracy of the estimation of the time to end becomes progressively more accurate.

In other words, the adaptive learning functions used by the method are repeatedly and continuously, (for any drying cycle) updated/improved based on the “actual drying conditions” of the dryer.

Moreover, the adaptation of adaptive learning functions of the end of cycle based on user feedback increases the satisfaction of the user. Indeed, the drying cycles are repeatedly tuned based on the user's personal sensitivity profile and/or preferences. Adaptive learning functions are self-optimized, cycle after cycle, based on both user feedback and historical data stored during the previous drying cycles. It follows that the dryer is able to configure itself based on users' needs.

Because of the automatic adaptation of the adaptive learning functions, it is possible to reduce the number of laboratory tests used to define parameters in the dryer. e.g., moisture thresholds, used to estimate the end of cycle and the time to end. It follows that the method simplifies laboratory tuning procedure to calibrate and optimize such algorithms in order to get best performance.

It has thus been shown that the present invention allows all the set objects to be achieved.

While the present invention has been described with reference to the particular embodiments shown in the figures, it should be noted that the present invention is not limited to the specific embodiments illustrated and described herein; on the contrary, further variants of the embodiments described herein fall within the scope of the present invention, which is defined in the claims.

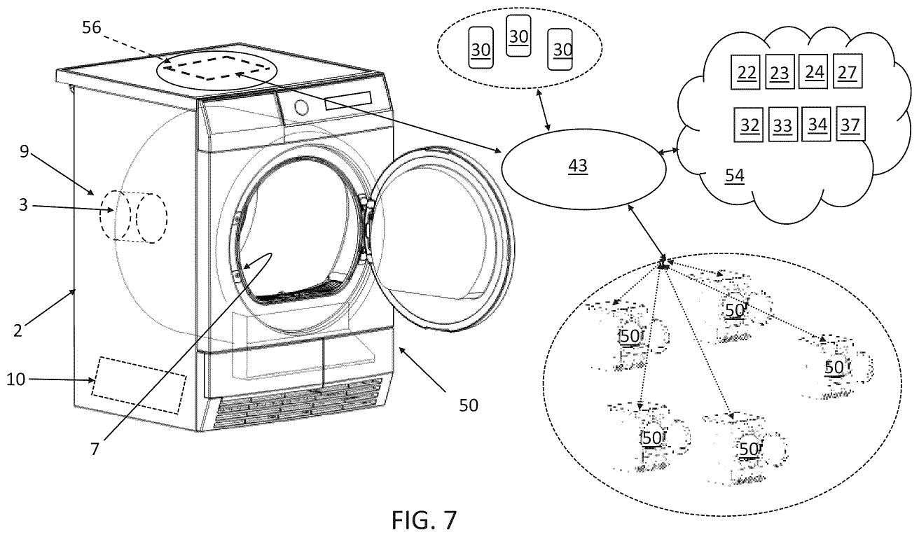

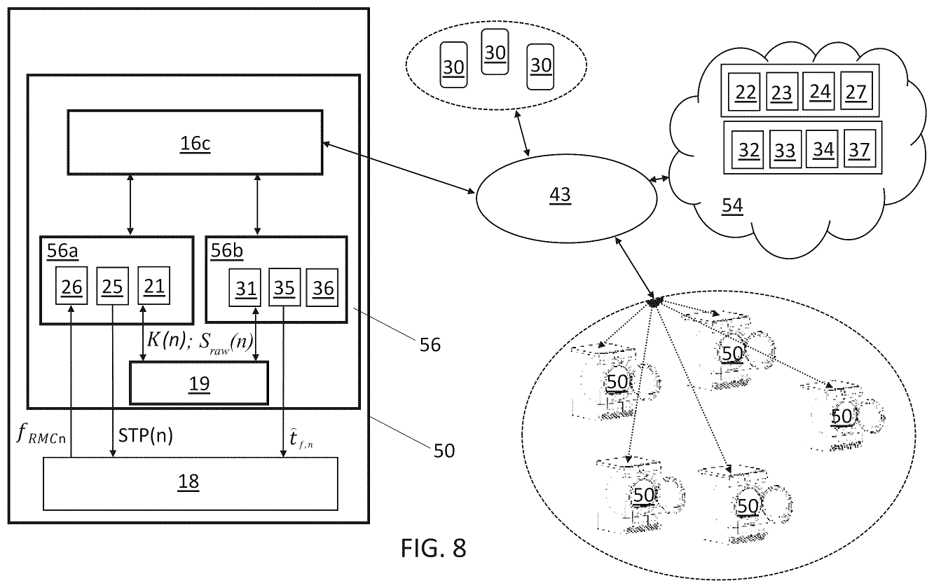

The embodiment illustrated in FIGS. 7 and 8 concerns a dryer 50, which is similar to the dryer 1 shown in FIG. 1 and the component parts of which will be designated, where possible, by the same reference numbers as those that designate corresponding parts of the dryer 1.

With reference to FIGS. 7 and 8, the dryer 50 differs from the laundry dryer 1 shown in FIG. 1 in that it is configured to communicate, for example, by the communication module 16c and the communication system 43 with a remote computing system 54.

Preferably, the remote computing system 54 may comprise one or more cloud computer systems having conveniently large storage and high computational power.

Moreover, the dryer 50 differs from the laundry dryer 1 shown in FIG. 1 in comprising an electronic control system 56 which has a simplified computational architecture compared with that of the electronic control system 16 of the laundry dryer 1.

With reference to the exemplary simplified embodiment illustrated in FIGS. 7 and 8, the electronic control system 56 of the laundry dryer 50 differs to the electronic control system 16 of the laundry dryer 1 in that its data processing unit 56a does not comprise the collecting module 22, the memory module 23, the computational module 24 and the adaptive module 27.

According to this embodiment, the collecting module 22, the memory module 23, the computational module 24 and the adaptive module 27 are comprised in the remote computing system 54.

Data processing unit 56a comprises the data/signal extracting module 21, the control module 25, and the ending collecting module 26. The ending collecting module 26 of the data processing unit 56a may be configured to receive the feedback signal f_{RMC,n} from the control interface 18 and/or from the user communication device 30. The control module 25 of the data processing unit 56a may be configured to provide indication about the end of cycle to the user, by means of the control interface 18 and/or the user communication device 30.

According to this embodiment, the data/signals extracting module 21 of the data processing unit 56a communicates the informative features I(n) and signals S_{proc,t}(n) to the collecting module 22 of the remote computer system 54 by the communication system 43. According to that embodiment, the computational module 24 of the remote [symbol] computer system 54 communicate the estimates remaining moisture content [symbol] of the laundry load to the control module 25 of the data processing unit 16a by the communication system 43. According to that embodiment, the ending collecting module 26 of the data processing unit 56b communicates the vector V_{EOC,n} to the adaptive module 27 of the remote computer system 54 by the communication system 53.

It is understood that: data/signal extracting module 21, the collecting module 22, the memory module 23, the computational module 24, the control module 25, the ending collecting module 26 and the adaptive module 27 of remote computing system 54, individually operate according to the method above disclosed.

Moreover, the dryer 50 shown in FIGS. 7 and 8 differs from the laundry dryer 1 shown in FIG. 1 in that its data processing unit 56b does not comprise the collecting module 32, the memory module 33, the computational module 34 and the adaptive module 37.

According to this embodiment, the collecting module 32, the memory module 33, the computational module 34 and the adaptive module 37 are comprised in the remote computing system 54.

Data processing unit 56b comprises the data/signal extracting module 31, the control module 35, and the ending collecting module 36. The ending collecting module 36 of the data processing unit 56a may be configured to provide indication about the estimated time end to the user, by means of the control interface 18 and/or the user communication device 30.

According to this embodiment, the data/signals extracting module 31 of the data processing unit 56b communicates the informative features I(n) to the collecting module 32 of the remote computer system 54 by the communication system 43. According to that embodiment, the computational module 34 of the remote computer system 54 communicate the estimated time to end the control module 35 of the data processing unit 56b by the communication system 43. According to that embodiment, the ending collecting module 36 of the data processing unit 56b communicates the vector V_{TTE,n} to the adaptive module 37 of the remote computer system 54 by the communication system 53.

It is understood that: data/signal extracting module 31, the collecting module 32, the memory module 33, the computational module 34, the control module 35, the ending collecting module 36 and the adaptive module 37 of remote computing system 54, individually operate according to the method above disclosed.

It is further understood that according to possible embodiments, besides electric motor signals and humidity sensor signals, the considered informative features (I(n)) and signals S_{raw}(n) and cycle parameters K(n) collected by the electronic control system 16 may comprise other information, parameters and signals. For example the electronic control system 16 may collect information gathered from a combination of different load humidity sensor (also with different technologies if possible) positioned in different spots; information gathered from temperature sensors (both for the process temperature and the environmental temperature); information gathered from air humidity sensors (both for the process humidity and the environmental humidity); information gathered from the power that is absorbed by the machine components (e.g., by the compressor); information gathered from sensors capturing belt tension; information gathered from load cells applied to the rollers supporting the drum; information gathered from air pressure sensors (e.g., pressure drops on the drum or on the drying air filter); information gathered from anemometers (e.g., air mass flow rate) information gathered from a camera that captures the laundry loading process or the actual laundry drying process; information gathered from a thermal camera (or infrared sensors, or thermopiles) that captures the laundry loading process or the laundry actual drying process; information gathered through an App used by the customer on his/her mobile phone/tablet (e.g., basic description of laundry load composition or size); information gathered through a voice controlled device used by the customer (before loading the machine but also after the cycle end); information gathered from other machines of the same user and/or involved in the same laundry process (a washing machine owned by the same user); information gathered from community interactions, but also from other machines in a similar environment (a geolocalization might be performed) or region e.g., average water conductivity of the region, average dryness preferences.

With reference to FIGS. 7 and 8, the remote computing system 54 may be configured to selectively communicate with a plurality of dryers 50 and perform for any of them, the method above disclosed. Accordingly, the remote computing system 54 may be configured to perform, for each dryer 50, an estimation of the remaining moisture content [symbol] in order to determine the end of cycle condition, and/or an estimation of the time to end. Accordingly, the remote computing system 54 may be further configured to accumulate/store all data/signals provided by dryers 50 and use all collected data to adapt the adaptive learning functions [symbol] and/or [symbol] to be used by the laundry drier 50 to estimate the end of cycle and the time to end \hat{t}_{f,n}.

Applicant has found that cloud-based computation allows to update model parameters in order to store updated models always locally in the dryer, considering optimality also when connection is lost or directly required model outputs to enable the construction of more complex and refined models that live completely in the cloud.

According to this embodiment it is possible to derive general insight along with habits from groups of dryer users. Employing, e.g., unsupervised machine learning algorithms, it will be feasible to cluster user preferences based on different factors and then analyse such clusters with their correlations.

Aggregating results and feedbacks from several dryer-users, allows remote computing system 54 to detect, for example, that dryer systematically underestimates time to end for small loads, and/or that users are unhappy with the drying results on large loads. This elaboration conveniently provides indication on specific calibration improvements to be performed in the dryers, such as calibrating time to end procedure for small loads, and/or calibration of end of cycle condition for large loads and, in case, correcting such tunings in all appliances by means of remote software update procedures.

The remote computing system 54 may also groups data considering geographical distribution of the dryers 50. For instance, it could be the case that, in some regions, dryer users are less satisfied with the final dryness results, and a strong correlation with a common field condition like, e.g., water conductivity or operating temperature might be noticed. In that case, a pre-set tuning, based on such preferences, might be thereafter considered as default setting for driers used in that area. Exploiting these aggregation and analysis techniques on growing amounts of data, precious insight about customers can be derived. Furthermore, the adaptive nature of said algorithms may allow the remote computing system 54 to adapt models based on user preferences associated to seasonality.

1.-20. (canceled)

21. A method to estimate the time to end (\hat{t}_{f,n}) of a laundry-drying cycle (DC(n)) performed by a laundry drying machine, wherein the laundry drying machine comprises:
an outer casing;
a rotatable drum arranged inside the outer casing and configured to receive a laundry-load to be dried;
an electric motor that rotates the laundry drum based on a laundry-drying cycle (DC(n)); drying means for drying the laundry-load in the drum based on the drying cycle (DC(n)); and
an electronic control system comprising a data processing module and a sensor system configured to provide cycle parameters (K(n)) and signals (S_{raw}(n)) indicative of at least the moisture of the laundry-load, wherein the method comprises the steps of:
a) defining a time to end learning function ( [symbol] );
b) during a drying cycle (DC(n)), collecting cycle parameters (K(n)) and signals (S_{raw}(n));
c) determining informative features (I(n)) based on the collected cycle parameters and signals (K(n), S_{raw}(n));
d) during the execution of the in cycle (DC(n)), implementing the time to end learning function ( [symbol] ) by the data processing module based on the determined informative features (I(n)) to cause the data processing module to estimate the time to end (\hat{t}_{f,n}) of the current drying cycle (DC(n));
e) at the end of the drying cycle (DC(n)), receiving a cycle feedback indicative of the actual duration (t_{f,n}) of the executed drying cycle (DC(n));
f) adapting the time to end learning function ( [symbol] ) by the data processing module based on the cycle feedback indicative of the actual duration (t_{f,n}) in order to determine an adapted time to end learning function ( [symbol] ); and
g) during the next drying cycle (DC(n+1)), implementing the adapted time to end learning function ( [symbol] ) by the data processing module to cause the data processing module (16b)(56b) to estimate the time to end (\hat{t}_{f,n}) of the next drying cycle (DC(n+1)).

22. The method of claim 21, wherein:
the sensor system is configured to provide load moisture signals (sₜ) indicative of the moisture of the laundry load, and/or drum motor torque signals (mₜ) indicative of the torque provided by the electric motor,
the informative features (I(n)) comprise:
the mean (μ_{s,n}) of the load moisture signals in a predefined interval of the drying cycle (DC(n)), the variance (σ_{s,n}) of the moisture sensor signals in a predefined interval of the drying cycle (DC(n)); and
the mean of the electrical torque signals (μ_{m,n}) in a predefined interval of the drying cycle (DC(n)).

23. The method of claim 22, wherein:
the time to end learning function ( [symbol] (n)) used to estimate the time to end (\hat{t}_{f,n}) of the current drying cycle (DC(n)) is based on the linear mathematical system
$${\hat{t}}_{f , n} = {M}_{TTE , n} ( {μ}_{s , n} , {σ}_{s , n} , {μ}_{m , n} ) = {α}_{0 , n} + {α}_{1 , n} {μ}_{s , n} + {α}_{2 , n} {σ}_{s , n} + {α}_{3 , n} {μ}_{m , n}$$
wherein \hat{t}_{f,n} is the estimated time to end of the current drying cycle, α_{i,n} are coefficients of the linear mathematical model/function, μ_{s,n} is the mean of the load moisture sensor signal, σ_{s,n} is the variance of the moisture sensor signals and μ_{m,n} is the mean of the motor torque signals.

24. The method of claim 23, wherein Aₙ=[α_{0,n} α_{1,n} α_{2,n}α_{3,n}]^{T} is a vector of parameters minimizing the sum of the squares of the residuals of the mathematical matrix
$${\underbrace{[ \begin{matrix}1 & {μ}_{s , 1} & {σ}_{s , 1} & {μ}_{m , 1} \\ 1 & {μ}_{s , 2} & {σ}_{s , 2} & {μ}_{m , 2} \\ ⋮ & ⋮ & ⋮ & ⋮ \\ 1 & {μ}_{s , n} & {σ}_{s , n} & {μ}_{m , n}\end{matrix} ]}}_{{Φ}_{TTE , n}} {A}_{n} = {\underbrace{[ \begin{matrix}{t}_{f , 1} \\ {t}_{f , 2} \\ ⋮ \\ {t}_{f , n}\end{matrix} ]}}_{{T}_{TTE , n}}$$
wherein Φ_{TTE,n} is a regression model matrix that contains the informative features I(n) collected during the operating of the laundry drying machine, T_{TTE,n} is a regression model matrix that contains the actual durations of the drying cycles DC(n) collected during the operating of the laundry drying machine, and wherein the method further comprises the steps of:
determining, during the drying cycles (DC(n)), history data collections (H_{TTE,n}) a set of variables that contain all the information of the past cycles needed to compute the update of the model when new data is available; and
determining the vector Aₙ by performing the matrix calculation
$${A}_{n} = {( {Φ}_{TTE , n}^{T} {Φ}_{TTE , n} )}^{- 1} {Φ}_{TTE , n}^{T} {Φ}_{TTE , n} .$$

25. The method of claim 24, further comprising:
determining a time to end vector (V_{TTE,n}=[μ_{s,n}, σ_{s,n}, μ_{m,n}, t_{f,n}]) at the end of the current cycle (DC(n); and
determining the drying cycles history data collections (H_{TTE,n}) of the current drying cycle (DC(n)) based on: drying cycles history data collections (H_{TTE,n-1}) determined during the previous drying cycles (DC(n−1)) and the time to end vector (V_{TTE,n}) determined during the current drying cycle (DC(n)).

26. The method of claim 25, further comprising the step of determining the time to end learning model ( [symbol] ) to be used during the next drying cycle (DC(n+1)) based on the drying cycles history data collections (H_{TTE,n}) of the current drying cycle (DC(n)).

27. The method of claim 21, wherein the time to end learning function ( [symbol] (n)) may be selected from the group consisting of polynomial models, linear/kernelized support vector models, random forests, and neural networks models.

28. The method of claim 21, wherein at least steps d), f) and g) are performed by a remote computing system.

29. The method of claim 21, further comprising the step of communicating the estimated time to end (\hat{t}_{f,n}) to a user communication device 30.

30. The method of claim 21, wherein step f) is implemented in response to a user command.

31. A laundry drying machine comprising:
an outer casing;
a rotatable drum arranged inside the outer casing and configured to receive a laundry-load to be dried;
an electric motor that rotates the laundry drum based on a laundry-drying cycle (DC(n));
drying means for drying the laundry-load in the drum based on the drying cycle (DC(n)); and
electronic control system comprising:
a data processing module; and
a sensor system configured to provide cycle parameters (K(n)) and signals (S(n)) indicative of at least the moisture of the laundry-load, wherein the data processing module is configured to:
a) define a time to end learning function ( [symbol] );
b) collect the cycle parameters and signals (K(n), S_{raw}(n)) during a drying cycle (DC(n)) by the sensor system;
c) determine informative features (I(n)) based on the collected cycle parameters and signals (K(n), S_{raw}(n));
d) implement the time to end learning function ( [symbol] ) based on the determined informative features (I(n)) during the execution of the drying cycle (DC(n)) to estimate a time to end (\hat{t}_{f,n}) of the current drying cycle (DC(n));
e) receive a cycle feedback indicative of the actual duration (t_{f,n}) of the executed drying cycle (DC(n)) at the end of the drying cycle (DC(n));
f) adapt the time to end learning function ( [symbol] ) based on the cycle feedback indicative of the actual duration (t_{f,n}) in order to determine an adapted time to end learning function ( [symbol] ); and
g) implement the adapted time to end learning function ( [symbol] ) during the next drying cycle (DC(n+1)) to estimate the time to end (\hat{t}_{f,n}) of the next drying cycle (DC(n+1)).

32. The laundry drying machine of claim 31, wherein the sensor system is configured to provide load moisture signals (sₜ) indicative of the moisture of the laundry load and/or drum motor torque signals (mₜ) indicative of the torque provided by the electric motor, and wherein the informative features (I(n)) comprise the mean (μ_{s,n}) of the load moisture signals, the variance (σ_{s,n}) of the moisture sensor signals in a predefined interval of the drying cycle (DC(n)), and the mean of the electrical torque signals (μ_{m,n}) in a predefined interval of the drying cycle (DC(n)).

33. The laundry drying machine of claim 32, wherein the time to end learning function ( [symbol] (n)) used to estimate the time to end (\hat{t}_{f,n}) of the current drying cycle (DC(n)) is based on the linear mathematical system
$${\hat{t}}_{f , n} = {M}_{TTE , n} ( {μ}_{s , n} , {σ}_{s , n} , {μ}_{m , n} ) = {α}_{0 , n} + {α}_{1 , n} {μ}_{s , n} + {α}_{2 , n} {σ}_{s , n} + {α}_{3 , n} {μ}_{m , n}$$
wherein \hat{t}_{f,n} is the estimated time to end of the current drying cycle, α_{i,n} are coefficients of the linear mathematical model/function, μ_{s,n} is the mean of the load moisture sensor signal, σ_{s,n} is the variance of the moisture sensor signals and μ_{m,n} is the mean of the motor torque signals.

34. The laundry drying machine of claim 33, wherein Aₙ=[α_{0,n} α_{1,n} α_{2,n} α_{3,n}]^{T} is a vector of parameters minimizing the sum of the squares of the residuals of the mathematical matrix
$${\underbrace{[ \begin{matrix}1 & {μ}_{s , 1} & {σ}_{s , 1} & {μ}_{m , 1} \\ 1 & {μ}_{s , 2} & {σ}_{s , 2} & {μ}_{m , 2} \\ ⋮ & ⋮ & ⋮ & ⋮ \\ 1 & {μ}_{s , n} & {σ}_{s , n} & {μ}_{m , n}\end{matrix} ]}}_{{Φ}_{TTE , n}} {A}_{n} = {\underbrace{[ \begin{matrix}{t}_{f , 1} \\ {t}_{f , 2} \\ ⋮ \\ {t}_{f , n}\end{matrix} ]}}_{{T}_{TTE , n}}$$
wherein Φ_{TTE,n} is a regression model matrix that contains the informative features I(n) collected during the operating of the laundry drying machine, T_{TTE,n} is a regression model matrix which contains the actual durations of the drying cycles DC(n) collected during the operating of the laundry drying machine, wherein the data processing module is configured to:
determine during the drying cycles DC(n), history data collections (H_{TTE,n}) a set of variables that contain all the information of the past cycles needed to compute the update of the model when new data is available; and
determine the vector Aₙ by performing the matrix calculation
$${A}_{n} = {( {Φ}_{TTE , n}^{T} {Φ}_{TTE , n} )}^{- 1} {Φ}_{TTE , n}^{T} {Φ}_{TTE , n}^{T} .$$

35. The laundry drying machine of claim 34, wherein the data processing module is configured to:
determine a time to end vector (V_{TTE,n}=[μ_{s,n}, σ_{s,n}, μ_{m,n}, t_{f,n}]) at the end of the current cycle (DC(n); and
determine the drying cycles history data collections (H_{TTE,n}) of the current drying cycle based on: drying cycles history data collections (H_{TTE,n-1}) determined during the previous drying cycles (DC(n−1)) and the time to end vector (V_{TTE,n}) determined during the current drying cycle (DC(n)).

36. The laundry drying machine of claim 35, wherein the data processing module is configured to:
determine the time to end learning model ( [symbol] ) to be used during the next drying cycle (DC(n+1)) based on the drying cycles history data collections (H_{TTE,n}) of the current drying cycle (DC(n)).

37. The laundry drying machine of claim 31, wherein the time to end learning function ( [symbol] (n)) is selected from the group consisting of polynomial models, linear/kernelized support vector models, random forests, and neural networks models.

38. The laundry drying machine of claim 31, wherein the data processing module is configured to communicate the estimated time to end (\hat{t}_{f,n}) to a user communication device.

39. The laundry drying machine of claim 31, wherein data processing module is configured to adapting the time to end learning function ( [symbol] ) in response to a user command.

40. A computer program comprising instructions to cause the data processing module of the electronic control system of the laundry drying machine to execute the steps a)-g) of claim 31.
